(19) United States
(12) Patent Application Publication
(10) Pub. No.: US 2018/0172034 A1
(43) Pub. Date: Jun. 21, 2018

(54) PLUNGER MEMBER USED FOR BELT TYPE CONTINUOUSLY VARIABLE TRANSMISSION

(71) Applicants: UNIPRES CORPORATION, Kanagawa (JP); Nippon Steel & Sumitomo Metal Corporation, Tokyo (JP)

(72) Inventors: Masamichi MIWA, Kanagawa (JP); Katsuyo FUKUMOTO, Kanagawa (JP); Ryuta MORI, Kanagawa (JP); Yosuke SUGISAWA, Kanagawa (JP); Teruki HAYASHIDA, Tokyo (JP)

(21) Appl. No.: 15/897,167

(22) Filed: Feb. 15, 2018

Related U.S. Application Data
(63) Continuation of application No. PCT/JP2016/073944, filed on Aug. 16, 2016.

(30) Foreign Application Priority Data
Aug. 20, 2015 (JP) 2015-162931

(51) Int. Cl. F15B 15/14; F16H 55/56; F16J 1/00; B21D 22/26; B21K 1/18; C23C 8/32

(52) U.S. Cl. CPC F15B 15/1447; F16H 55/56; F16J 1/001; F16H 9/18; B21K 1/18; C23C 8/32; B21D 22/26

(57) ABSTRACT

A plunger member 3 used for a belt type continuously variable transmission is configured by cold press molding a blank material 32 according to deep-drawing molding, and closed forging, compression molding or a combined molding thereof, where during the cold press molding, a thickness of a bent corner portion 3f, which at least makes a sleeve portion 3c and a step-like formed portion (spring seating portion) 3d continuous to each other, is configured to be increased by 30% or more relative to a thickness of the blank material 32, and then a hardened surface layer 3B is configured to be formed on both of the entire front and back sides of the plunger member by performing a soft nitriding treatment.

The contents of the following Japanese patent application are incorporated herein by reference:

No. JP2015-162931 filed on Aug. 20, 2015 and

PCT/JP2016/073944 filed on Aug. 16, 2016.

### BACKGROUND

### 1. Technical Field

The present invention relates to a plunger member (also referred to as “piston member”) that is fixed to a shaft so as to face a movable-side pulley half body in a belt type continuously variable transmission to define a pulley oil chamber.

### 2. Related Art

This type of belt type continuously variable transmissions is configured, for example, as described in Patent Document 1, to include a drive pulley, the drive pulley including a fixed-side pulley half body and a movable-side pulley half body with a variable groove width therebetween, the drive pulley being provided on an input shaft; an pulley oil chamber; and a canceller oil chamber adjacent to the pulley oil chamber, where an endless belt is wound around the pulley oil chamber and a driven pulley, the driven pulley including a fixed-side pulley half body and a movable-side pulley half body with a variable groove width therebetween, the driven pulley provided on an output shaft (shaft), the pulley oil chamber causing the movable-side pulley half body to operate.

Further, the pulley oil chamber and the canceller oil chamber are configured by defining, by the plunger member arranged so as to face the movable-side pulley half body, an oil chamber that is configured with a cylinder member fixed to the movable-side pulley half body.

The plunger member is configured to have an expanding flange portion, the expanding flange portion having a large diameter, being provided on one end side and slidably abutting on the cylinder member, have a sleeve portion, the sleeve portion having a small diameter, being provided on the other end side and being fit to the shaft, and have one or more step-like formed portions, the one or more step-like formed portions having diameters stepwisely smaller from the expanding flange portion and continuing to the sleeve portion. One of the step-like formed portions configures a spring seating stair portion on which a spring in a compressed state is seated so as to bias the movable-side pulley toward the fixed-side pulley.

Also, the sleeve portion is fixed by being sandwiched between a stair portion formed in a middle of the output shaft, and a ball bearing adhered to the output shaft.

Although the plunger member used for a belt type continuously variable transmission configured in this way may be configured with forged parts in some cases, in response to a recent request of light weight of automobile parts and cost reduction, the plunger member is manufactured by press molding a hot rolled steel plate raw material consisting of a hot rolled steel plate raw material (JIS standard: SAPH440) (as a conventional hot rolled steel plate raw material, refer to the descriptions of Patent Documents 2 to 4).

Therefore, the press molding of the plunger member is performed, by a press molding machine, by cold deep-drawing molding a disk-shaped blank material consisting of the above-described hot rolled steel plate raw material.

Further, the plunger member is configured so that a hardened inner layer is formed by performing cold deep-drawing molding on the blank material by the press molding machine for multiple times to acquire a high strength, and in addition, after press molding, a hardened surface layer is formed by performing a soft nitriding treatment in a thermal treatment tank at a high temperature (580° C.) in a gas atmosphere including ammonia to improve abrasion resistance.

In the plunger member configured by performing the soft nitriding treatment in this way, a hardened surface layer, a diffusion layer, and a hardened inner layer are sequentially formed from a front surface of the plunger member in a plate thickness direction. Among the layers, the hardened surface layer and the diffusion layer are layers diffused and formed according to a diffusion of nitrogen from the front surface of the plunger member by the soft nitriding treatment, and the hardened inner layer is a layer formed from the raw material that is hardened by press molding.

### PATENT DOCUMENT

[Patent Document 1] Japanese Patent Publication No. 3223241

[Patent Document 2] Japanese Patent Application Publication No. 2012-177167

[Patent Document 3] Japanese Patent Publication No. 2742951

[Patent Document 4] Japanese Patent Application Publication No. 2007-332417

In a state in which a high-pressure hydraulic pressure is applied to the inside of the pulley oil chamber in the above-described belt type continuously variable transmission, it is necessary to prevent a crack from being generated at a bent corner portion formed on a continuous part between the sleeve portion and the step-like formed portion in the plunger member configured to have the hardened inner layer.

The sleeve is substantially fixed to the output shaft. Accompanying a speed-change operation by a movement on the output shaft of the movable-side pulley half body relative to the fixed-side pulley half body, a force, which causes the bent corner portion to expand outward due to the hydraulic force of the pulley oil chamber, is applied to the bent corner portion. Accordingly, the bent corner portion is permanently deformed in spite of including the hardened surface layer that has Vickers hardness of 400 Hv or more. It is considered that accordingly the crack phenomenon occurs.

Here, the inventors of the present application investigated reasons why the permanent deformation of the plunger member occurs in spite of being configured to have the hardened inner layer.

As a result, the inventors of the present application found out, according to their keen research, that in a process of forming the hardened surface layer by performing, in a thermal treatment tank at the high temperature, the soft nitriding treatment on the plunger member manufactured by using the above-described hot rolled steel plate raw material, the hardened inner layer formed by deep-drawing molding by a press molding machine in a cold blank material is softened, and the strength is reduced.

That is, the inventors of the present application performed a thermal treatment in a thermal treatment tank at a nitriding treatment temperature set to 580° C. for treatment time of 60 to 240 minutes in a gas atmosphere including ammonia to form a hardened surface layer by performing the soft nitriding treatment on the plunger member manufactured by deep-drawing press molding the disk-shaped blank material consisting of hot rolled steel plate raw material for multiple times. The inventors of the present application found out that in this case, the hardened inner layer formed by deep-drawing press molding is softened regardless of the thermal treatment time.

The hardness of the hardened inner layer of the plunger member was measured. As a result, it was known that the hardness specially obtained by deep-drawing molding is less than 180 Hv in some portions.

Here, the inventors of the present application keenly investigated factors causing the hardness of the hardened inner layer to be reduced. As a result, it was found that the softening occurs by performing the nitriding treatment at the high temperature of 580° C.

That is, caused by performing the nitriding treatment at the high temperature of 580° C., a movement of a dislocation of an inner structure of the hardened inner layer formed by press molding occurs earlier.

The inventors of the present application found out that the softening phenomenon of the hardened inner layer occurs due to the movement and disappearance of the dislocation of hardening factors of the hardened inner layer formed by plastically deforming according to the deep-drawing press molding, and that the softening phenomenon of the hardened inner layer occurs due to material components configuring the plunger member.

Here, the inventors of the present application considered again, based on the softening factors of the hardened inner layer due to the soft nitriding treatment in the above-described hardened inner layer, the inventions described in Patent Documents 3 and 4 among the above-described Patent Documents, Patent Documents 3 and 4 focusing on the softening phenomenon of the hardness of the hardened inner layer due to the soft nitriding treatment.

First, Patent Document 3 has disclosed a technique of preventing the hardness of the hardened inner layer from being reduced due to the soft nitriding treatment in the hot rolled steel plate for nitriding treatment.

Accordingly, a component configured to contain Cu of 0.8 to 1.7 mass % has been proposed as a chemical component in the hot rolled steel plate for nitriding treatment.

This is intended to increase, by containing Cu in the hot rolled steel plate for nitriding treatment, the hardness of the inside of the steel plate according to another mechanism carried by the Cu even if a working hardness is lost due to the soft nitriding treatment.

However, because the hot rolled steel plate for nitriding treatment disclosed in Patent Document 3 contains a large amount of Cu that is precious metal, the raw material cost significantly increases.

In addition, in order to maintain the surface quality in high quality and prevent hot brittleness, Ni being within a range of 0.15 to 0.7 mass % has to be added to the hot rolled steel plate for nitriding treatment disclosed in Patent Document 3, as the embodiment disclosed in Table 1 of Patent Document 3, and this is also the reason causing the cost increase.

Therefore, if the plunger member is configured by using the hot rolled steel plate for nitriding treatment disclosed in Patent Document 3, the plunger member cannot be applied to at least automobile parts and the like to which a request of cost reduction has been made limitlessly.

Also, Patent Document 4 has disclosed a steel plate for nitriding treatment intended to uniform the hardness in a plate thickness direction. Accordingly, the steel plate for nitriding treatment is configured so that at least one type selected from Ti, V, Zr is set to have a total content set equal to or less than 0.05% and set within a specific range, and further, a total content of Cr and/or Mo is set to 0.1, and furthermore, contents of Cr, Si, Cr, Mn, and Mo are set to satisfy a specific relation.

However, the steel plate for nitriding treatment disclosed in Patent Document 4 has been set to “use a steel plate having a plate thickness of approximately 3 mm or less, preferably approximately 2.5 mm or less” to more effectively utilize the characteristic of “providing nitride having a uniform hardness distribution in the plate thickness direction after the nitriding treatment” (refer to the descriptions of [0024] and the like of Patent Document 4).

According to the above, to increase the inner hardness of the steel plate within practical treatment time, the applied plate thickness is limited.

Furthermore, the hardness distribution in the plate thickness direction of the steel plate for nitriding treatment disclosed in Patent Document 4 is a hardness distribution of the steel plate having the plate thickness of 1.0 mm (refer to the descriptions of FIG. 1 and FIG. 2 of Patent Document 4).

Generally, a depth of the nitriding diffusion layer in the soft nitriding treatment is approximately 0.5 mm in the plate thickness direction. Accordingly, it can be estimated that regarding the hardening according to the nitriding diffusion layer on both of the front and back sides of the steel plate for nitriding treatment disclosed in Patent Document 4, the hardness in the plate thickness direction increases, the plate thickness being totally 1 mm.

In the steel plate for nitriding treatment disclosed in Patent Document 4, it is difficult to increase the hardness of the inside of the steel plate that has a thicker plate thickness, for example, has a plate thickness of 4 mm or more. No description for a demonstration of the above is found in Patent Document 4.

Therefore, the invention described in Patent Document 4 cannot be applied to the plunger member configured by using a steel plate having a plate thickness of 4 mm or more required for having a rigidity and strength capable of withstanding a high-pressure hydraulic pressure applied thereto from the inside of a pulley oil chamber and of withstanding repeated speed-change operations as the above-described belt type continuously variable transmission.

Here, in consideration of the above-described conventional technical issues, the present invention suppresses the softening phenomenon of the hardened inner layer caused by performing the soft nitriding treatment for forming the hardened surface layer even if configuring by using the hot rolled steel plate raw material having a desired plate thickness. Accordingly, a tough and inexpensive plunger member used for the belt type continuously variable transmission is provided, the plunger member including a hardened inner layer that has the hardness of 180 Hv or more in Vickers hardness.

### SUMMARY

The plunger member according to an embodiment of the present invention is fixed to a shaft so as to face a movable-side pulley half body configuring a pulley together with a fixed-side pulley half body in a belt type continuously variable transmission to define an oil chamber formed by a cylinder member into a pulley oil chamber and a canceller oil chamber. The plunger member includes an expanding flange portion having a large diameter, the expanding flange portion formed on one end side by press molding a blank material and slidably abutting on the cylinder member, and a sleeve portion having a small diameter, the sleeve portion formed on the other end side and fit and fixed to the shaft. The plunger member includes one or more step-like formed portions having diameters stepwisely smaller from the expanding flange portion and continuing to the sleeve portion. The plunger member is configured by cold press molding the blank material according to the deep-drawing molding, and closed forging, compression molding or a combined molding thereof, where during the cold press molding, a thickness of a bent corner portion, which at least makes the sleeve portion and the step-like formed portion continuous to each other, is configured to be increased by 30% or more relative to a thickness of the blank material, and then the hardened surface layer is formed on both of entire front and back sides of the plunger member by performing a soft nitriding treatment.

The plunger member is configured by cold press molding the blank material according to the deep-drawing molding, and closed forging, compression molding or the combined molding thereof. The hardened surface layer is formed on both of the entire front and back sides of the plunger member by configuring the thickness of the bent corner portion, which makes the sleeve portion and the step-like formed portion continuous to each other, to be increased by 30% or more relative to the thickness of the blank material, and then performing the soft nitriding treatment. Accordingly, the softening phenomenon due to the dislocation occurring in the hardened inner layer existing in inner side than the hardened surface layer during the soft nitriding treatment can be suppressed even if the hardened surface layer is formed by performing the soft nitriding treatment, and a tough and inexpensive plunger member can be provided.

Also, according to the plunger member according to an embodiment of the present invention, the hardened surface layer is configured to have a thickness of 4 μm or more relative to both of the outermost and the backmost surfaces of the plunger member.

In the plunger member according to an embodiment of the present invention, the hardened surface layer is configured to have a thickness of 4 μm or more relative to both of the outermost and the backmost surfaces of the plunger member. Accordingly, the hardened inner layer in the bent corner portion after the soft nitriding treatment is configured to have the hardness of 180 Hv or more in Vickers hardness. Therefore, a force causing the bent corner portion to expand outward due to the hydraulic force of the pulley oil chamber in the bent corner portion can be suppressed, and the abrasion resistance of a spring seating portion against the biasing force according to the spring can be improved.

Also, according to the plunger member according to another embodiment according to the present invention, the hardened surface layer formed by the soft nitriding treatment is configured to have the hardness of 400 Hv or more in Vickers hardness. Therefore, the abrasion resistance of the spring seating portion against the biasing force according to the spring can be improved.

Also, according to the plunger member according to another embodiment according to the present invention, the entire plunger member is configured to be formed having an equivalent plastic strain amount of 0.4 or more. Accordingly, the hardened inner layer of the plunger member is sufficiently hardened. By applying the appropriate soft nitriding treatment condition to the plunger member, the softening phenomenon of the hardened inner layer can be suppressed.

Furthermore, in manufacturing a relatively small plunger member as a press-molded article by press-molding working, the equivalent plastic strain amount of the entire plunger member is set to 0.4 or more. Accordingly, it is advantageous when performing a thickness-increase working on the bent corner portion by deep-drawing molding, and closed forging, compression molding or the combined molding thereof

Also, according to the plunger member according to another embodiment according to the present invention, the bent corner portion making the sleeve portion and the step-like formed portion continuous to each other is configured to be provided with the equivalent plastic strain amount of 1.0 or more. Accordingly, in particular, in the bent corner portion, the hard portion according to the hardened inner layer can be maintained and the force causing the bent corner portion to expand outward due to the hydraulic force of the pulley oil chamber can be suppressed, and the abrasion resistance of the spring seating portion against the biasing force according to the spring can be improved.

It should be noted that the equivalent plastic strain amount is a value represented by the following expression (1).

Equivalent plastic strain amount={[(eX−eY)²+(eY−eZ)²+(eZ−eX)²]^{0.5}}/2 EXPRESSION (1)

Note that eX, eY, and eZ are respectively as the following expressions.

ex=ln[1+(Lx1−Lx0)/Lx0] EXPRESSION (2)

ey=ln[1+(Ly1−Ly0)/Ly0] EXPRESSION (3)

ez=ln[1+(Lz1−Lz0)/Lz0] EXPRESSION (4)

Also, Lx0, Lx1, Ly0, Ly1, Lz0, and Lz1 are as the followings. Lx0: a length in a main stress direction within a plate surface of the bent corner portion before working;

Lx1: a length in the main stress direction within the plate surface after working;

Ly0: a length in a direction orthogonal to Lx0 within the plate surface before working;

Ly1: a length in the direction orthogonal to Lx0 within the plate surface after working;

Lz0: a length in a plate thickness direction before working; and

Lz1: a length in the plate thickness direction after working

Also, because in another embodiment according to the present invention, the hardened inner layer, which exists in an inner layer portion than the hardened surface layer in the plunger member, is formed having Vickers hardness of 180 Hv or more, the force causing the bent corner portion to expand outward due to the hydraulic force of the pulley oil chamber in the bent corner portion can be suppressed, and the abrasion resistance of the spring seating portion against the biasing force according to the spring can be improved.

### EFFECT OF THE INVENTION

The plunger member according to the present invention is configured by cold press molding the blank material according to the deep-drawing molding, and closed forging, compression molding or the combined molding thereof. The thickness of the bent corner portion making the sleeve portion and the step-like formed portion continuous to each other is configured to be increased by 30% or more relative to the thickness of the blank material. Further, the hardened surface layer is formed by performing the soft nitriding treatment on both of the entire front and back sides of the plunger member. Accordingly, even if the hardened surface layer is formed by performing the soft nitriding treatment, the softening phenomenon due to the dislocation occurring in the hardened inner layer existing in the inner side than the hardened surface layer during the soft nitriding treatment can be suppressed, and the tough and inexpensive plunger member can be provided.

### BRIEF DESCRIPTION OF THE DRAWINGS

FIG. 1 is a longitudinal section view showing a driven side of a belt type continuously variable transmission adopting one embodiment.

FIG. 2 is a partially-broken perspective view showing an enlarged plunger member shown in FIG. 1.

FIG. 3-1 is an explanatory drawing of a molding step by pressing the plunger member shown in FIG. 2, and is a perspective view of the blank material.

FIG. 3-2 is an explanatory drawing of a cold drawing molding step by pressing.

FIG. 3-3 is an explanatory drawing of a cold-rolling working step by closed forging by pressing, compression molding, or a combined molding thereof.

FIG. 4-1 is an explanatory drawing showing in detail the cold-rolling working step shown in FIG. 3-3, and is a drawing showing a state in which an intermediate member of the plunger member according to one embodiment is set into a mold for cold rolling working.

FIG. 4-2 is a drawing showing a state in which a step-like formed portion of the intermediate member is rolled from a side-surface direction.

FIG. 4-3 is a drawing showing a state in which the step-like formed portion of the intermediate member is rolled from an end-surface direction.

FIG. 5 is an explanatory drawing showing an enlarged inside of a circle indicated by one-dotted chain lines in FIG. 2.

FIG. 6 is a component table of chemical compositions for materials a to c for trial, which configure the plunger member according to one embodiment.

FIG. 7 is a drawing showing mechanical properties of each of the material signs a to c as the materials for trial configuring the plunger member according to one embodiment.

FIG. 8 is a drawing showing gas components per unit within a gas furnace in which a soft nitriding treatment is performed on the plunger member respectively configured with the materials a to c for trial according to one embodiment.

FIG. 9 is a drawing showing a gas furnace temperature (° C.) and treatment time (min) in a case of performing the soft nitriding treatment on the plunger member respectively configured with the material signs a to c for trial according to one embodiment.

FIG. 10-1 is a graph showing a relation among 0, an abrasion amount (mm) of an inner surface of a spring seating portion and Vickers hardness (Hv) of a hardened surface layer of the plunger member respectively configured with the material sign a for trial according to one embodiment.

FIG. 10-2 is a graph showing a relation among 0, the abrasion amount (mm) of the inner surface of the spring seating portion and the Vickers hardness (Hv) of the hardened surface layer of the plunger member configured with the material sign b for trial according to one embodiment.

FIG. 10-3 is a graph showing a relation among 0, the abrasion amount (mm) of the inner surface of the spring seating portion, and Vickers hardness (Hv) of the hardened surface layer of the plunger member configured with the material sign c for trial according to one embodiment.

FIG. 11 is a graph showing a relation between the abrasion amount (mm) of the inner surface of the spring seating portion and a depth (μm) of the hardened surface layer of the blank member configured with the material sign a according to one embodiment.

FIG. 12 is a graph showing a relation between the abrasion amount (mm) of the inner surface of the spring seating portion and the depth (μm) of the hardened surface layer of the blank member configured with the material sign b according to one embodiment.

FIG. 13 is a graph showing a relation between the abrasion amount (mm) of the inner surface of the spring seating portion and the depth (μm) of the hardened surface layer of the blank member configured with the material sign c according to one embodiment.

FIG. 14 is a table contrastingly showing the hardness (Hv) and thickness (μm) of the hardened surface layer in each of the plunger members respectively configured with the material signs a to c according to one embodiment.

FIG. 15 is a graph showing a relation between a plate thickness increase rate (%) and a strain amount (%) of the bent corner portion A of each of the plunger members respectively configured with the material signs a to c according to one embodiment. On the right side out of the frame in the drawing, described is the presence/absence of a remaining permanently strain of the plunger member when unloading the hydraulic pressure applied to the pulley oil chamber.

FIG. 16-1 is a table describing each processing temperature and treatment time according to respectively different soft nitriding treatment conditions T1 to T13 for the plunger members manufactured for trial by respectively using the materials a, b, c for trial according to one embodiment.

FIG. 16-2 is a table describing the soft nitriding treatment conditions 1 to 3 for the plunger members manufactured for trial by respectively using the materials a to c for trial according to one embodiment.

FIG. 17-1 is a graph showing a relation between the Vickers hardness of the hardened inner layer and the strain amount, which is measured by a strain gage, of the bent corner portion of the plunger member manufactured for trial by using the material a for trial based on the soft nitriding treatment condition described in FIG. 16-2.

FIG. 17-2 is a graph showing the relation between the Vickers hardness of the hardened inner layer and the strain amount, which is measured by the strain gage, of the bent corner portion of the plunger member manufactured for trial by using the material b for trial based on the soft nitriding treatment condition described in FIG. 16-2.

FIG. 17-3 is a graph showing the relation between the Vickers hardness of the hardened inner layer and the strain amount, which is measured by the strain gage, of the bent corner portion of the plunger member manufactured for trial by using the material sign c based on the soft nitriding treatment condition described in FIG. 16-2.

FIG. 18 is a graph showing the relation between the Vickers hardness of the hardened inner layer and the strain amount, which is measured by the strain gage, of the portions A to I in FIG. 2 of the plunger member manufactured for trial by using the material sign a based on the soft nitriding treatment condition described in FIG. 16-2.

FIG. 19 is a graph showing a relation between the Vickers hardness of the hardened inner layer and the strain amount, which is measured by the strain gage, of the bent corner portion when the hydraulic pressure of 10 MPa is applied to the plunger member manufactured for trial by using the material sign a based on the soft nitriding treatment condition described in FIG. 16-2.

FIG. 20 is a graph describing the equivalent plastic strain amount of the portions A to I in FIG. 2 of each of the plunger members 3 manufactured for trial by respectively using the materials a to c for trial based on the soft nitriding treatment condition described in FIG. 16-2.

FIG. 21 is a graph showing the relation between the Vickers hardness of the hardened inner layer and the strain amount, which is measured by the strain gage, of the portions A to I in FIG. 2 of the plunger member manufactured for trial by using the material b for trial based on the soft nitriding treatment condition described in FIG. 16-2.

FIG. 22 is a graph showing the relation between the Vickers hardness of the hardened inner layer and the strain amount measured by the strain gage, of the portions A to I in FIG. 2 of the plunger member manufactured for trial by using the material c for trial based on the soft nitriding treatment condition described in FIG. 16-2.

FIG. 23 is a graph describing a relation between the Vickers hardness (Hv) and the equivalent plastic strain amount of the plunger member when the plunger member is manufactured by using a material for trial which is a hot rolled steel plate having a composition shown in FIG. 6, having a tensile strength TS (MPa) shown in FIG. 7, and having a material thickness of 5.6 mm.

FIG. 24 is an explanatory drawing describing a method of performing a thickness-reduction working on the materials a to c for trial in FIG. 6 at room temperature.

FIG. 25 is an explanatory drawing describing a method of performing a thickness-increase working on the materials a to c for trial in FIG. 6 according to compression working by a press machine.

### DESCRIPTION OF EXEMPLARY EMBODIMENTS

The plunger member used for the belt type continuously variable transmission according to one embodiment suppresses the softening phenomenon of the hardened inner layer caused by performing the soft nitriding treatment for forming the hardened surface layer, even if the plunger member is configured by using the hot rolled steel plate raw material having a desired plate thickness. Accordingly, a tough and inexpensive plunger member having the hardened inner layer that has the hardness of 180 Hv or more in Vickers hardness can be provided.

Hereinafter, the plunger member according to one embodiment is described by using the drawings.

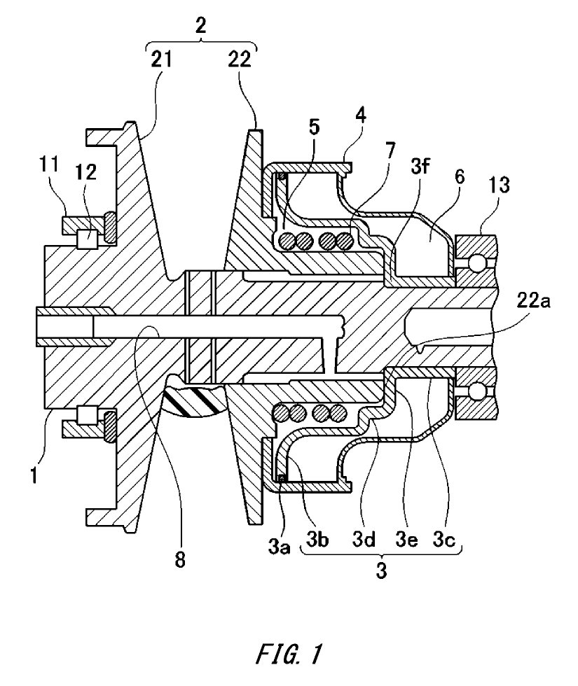

The belt type continuously variable transmission adopting the plunger member according to one embodiment is configured as shown in FIG. 1, for example.

That is, in FIG. 1, an output shaft 1 of the belt type continuously variable transmission has an intermediate portion in an axial direction supported by a central casing 11 via a roller bearing 12, and has a right end portion in FIG. 1 supported by a casing (not shown) via a ball bearing 13.

In an outer circumference of the output shaft 1, a fixed-side pulley half body 21 of a driven pulley 2 is integrally formed, and a movable-side pulley half body 22 that faces a right-side surface in the drawing of the fixed-side pulley half body 21 is supported slidably and relatively unrotatably in the axial direction of the output shaft 1 via a ball spline (not shown).

A plunger member 3 is arranged at the outer circumference of the output shaft 1 so as to face a side surface (the right-side surface in FIG. 1) of the movable-side pulley half body 22.

A cylinder member 4 is fixed to the right-side surface in FIG. 1 of the movable-side pulley half body 22, and a seal member 3a provided on the outer circumference of the plunger member 3 slidably abuts on the cylinder member 4. Accordingly, a pulley oil chamber 5 is formed by the movable-side pulley half body 22, the plunger member 3, and the output shaft 1.

Also, a canceller oil chamber 6 is formed between the plunger member 3 and the cylinder member 4. As a result, the plunger member 3 defines the pulley oil chamber 5 and the canceller oil chamber 6.

In the pulley oil chamber 5, a spring 7 is stored in a compressed state, the spring 7 biasing the movable-side pulley half body 22 toward the fixed-side pulley half body 21.

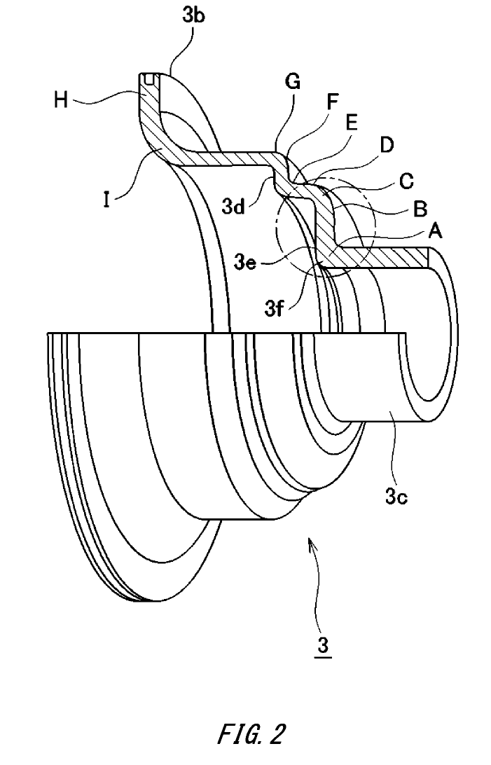

According to the above, the plunger member 3 is, as clearly shown in FIG. 2, configured to include an expanding flange portion 3b having a large diameter, the expanding flange portion 3b slidably abutting on the cylinder member 4 via the seal member 3a on a left end side (one end side), include a sleeve portion 3c having a small diameter, the sleeve portion 3c fit to the output shaft 1 on a right end side (the other end side), and include one or more step-like formed portions, which are two step-like formed portions 3d, 3e as shown in the drawing, having diameters becoming stepwisely smaller from the expanding flange portion 3b and continuing to the sleeve portion 3c.

In the two step-like formed portions 3d, 3e, the step-like formed portion 3d existing on the expanding flange portion 3b side configures a spring seating stair portion which allows the spring 7 to seat.

Also, as shown in FIG. 1, a bent corner portion 3f, which makes the other step-like formed portion 3e and the sleeve portion 3c of the plunger member 3 continuous to each other, abuts on the stair portion 22a of the movable-side pulley half body 22, and an end surface of the sleeve portion 3c abuts on the ball bearing 13 screwed to the output shaft 1 so that the plunger member 3 becomes to be arranged being adhered to the output shaft 1.

Further, an oil passage 8 that opens toward the pulley oil chamber 5 is bored inside the output shaft 1. The oil passage 8 is configured to supply control oil from a hydraulic pressure supplying apparatus (not shown) to the pulley oil chamber 5 so as to control a sliding operation of the movable-side pulley half body.

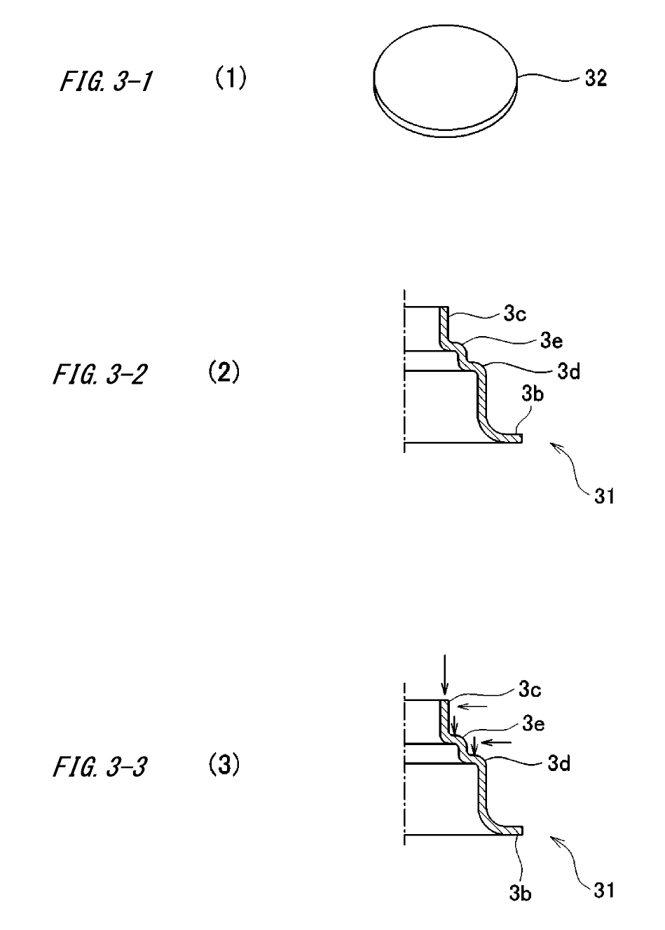

Then, in manufacturing the shown plunger member 3 according to the present invention, an intermediate member 31 is molded in advance by the press molding step shown in FIG. 3-2.

That is, as showing in FIG. 3-1, first, a disk-shaped blank material 32 is formed in advance by cutting a raw material of the hot rolled steel plate raw material by a press machine (not shown).

Next, as shown in FIG. 3-2, by deep-drawing molding the blank material 32 via the deep drawing step for multiple times by using a molding mold by another press machine (both are not shown), the intermediate member 31 is molded, which has the expanding flange portion 3b, the sleeve portion 3c, and the step-like formed portions 3d, 3e existing therebetween.

Next, for the intermediate member 31 as shown in FIG. 3-2, as shown by arrows in FIG. 3-3, in addition to the above-described deep-drawing molding, cold closed forging and compression molding or a combined molding thereof is further performed on the sleeve portion 3c in the end-surface direction (the thickness direction) and the step-like formed portions 3d, 3e in the side-surface direction (the surface direction) by another press machine by using a mold (not shown).

It should be noted that the “combined molding” in the present invention includes any one combination of the deep-drawing molding and closed forging, or the deep-drawing molding and compression molding, or the deep-drawing molding, closed forging, and compression molding.

Here, the closed forging and compression molding are performed on the intermediate member 31 at the steps shown in FIG. 4-1 to FIG. 4-3.

That is, the closed forging and compression molding are performed on the intermediate member 31 by using a cold molding mold 90 consisting of a lower die 91 and an upper die 92 respectively shown in FIG. 4-1 to FIG. 4-3.

The lower die 91 is configured to have a molding surface 91a corresponding to the shape of the inner surface of the plunger member 3.

Also, the upper die 92 is configured to include a side-surface direction rolling type 92A, which has a side-surface rolling surface 92a corresponding to outside surfaces of the step-like formed portions 3d, 3e of the plunger member 3, an end-surface direction rolling type 92B, which has an end-surface rolling surface 92b corresponding to the end surface of the sleeve portion 3c of the plunger member 3, and a press type 92C, which presses the side-surface direction rolling type 92A from an upper portion.

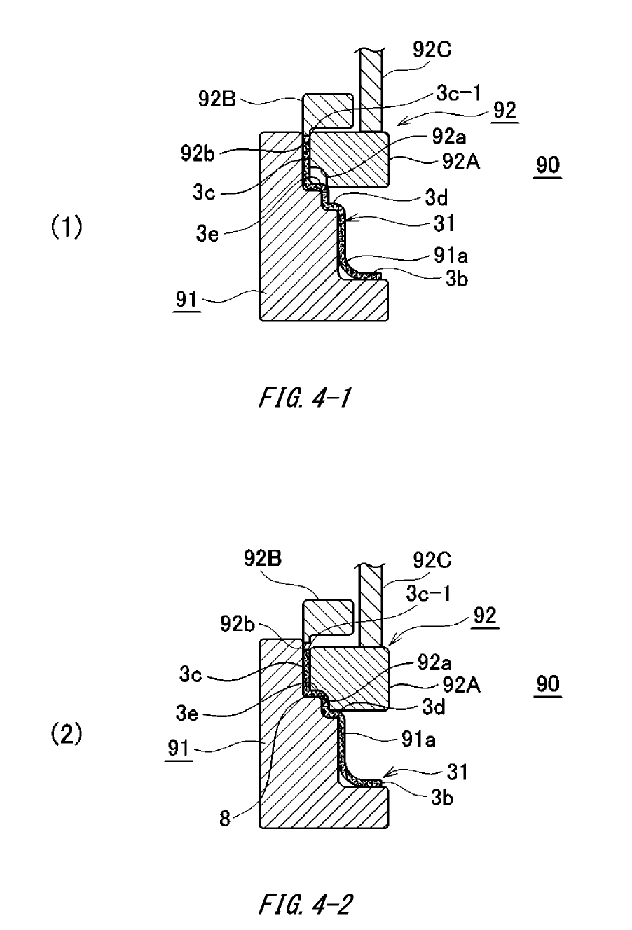

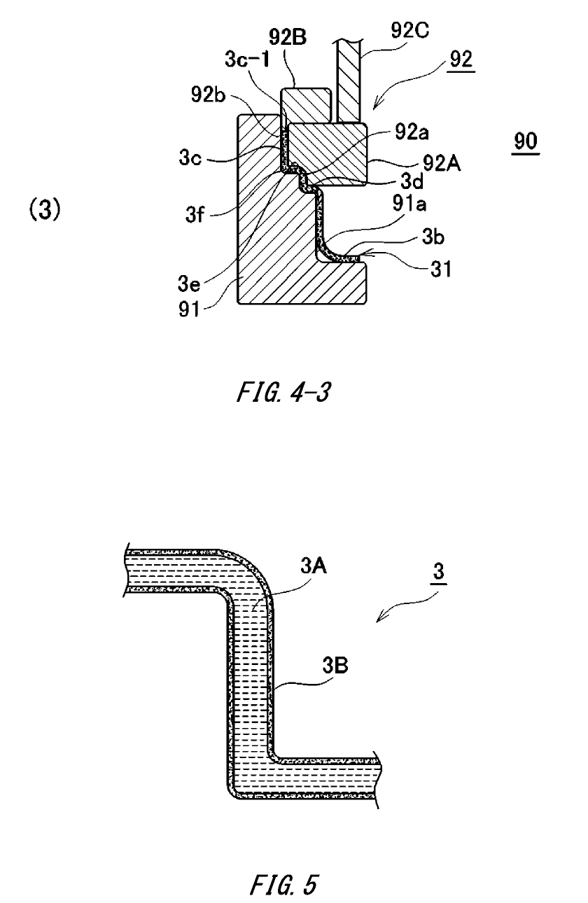

In the configuration, first, the intermediate member 31 formed by deep-drawing molding according to the deep drawing step shown in FIG. 3-2 is set on the molding surface 91a of the lower die 91, as shown in FIG. 4-1, and after that, the side-surface direction rolling type 92A and the end-surface direction rolling type 92B of the upper die 92 are set to abut on the intermediate member 31 in advance.

Next, as shown in FIG. 4-2, the side-surface direction rolling type 92A is pressing-molded by using the press type 92C.

Further, as shown in FIG. 4-3, the side-surface direction rolling type 92A presses the step-like formed portion 3e and the spring seating portion 3d, and the end-surface direction rolling type 92B presses the end surface 3c-1 so as to perform the cold closed forging, compression molding or the combined molding thereof on the sleeve portion 3c of the intermediate member 31 so that the plunger member 3 to which the working hardness is applied by high densification is obtained.

At this time, by filling up a space part formed by the molding surface 91a of the lower die 91 and the end-surface rolling surface 92a of the upper die 92 (refer to FIG. 4-2), the bent corner portion 3f, which makes the sleeve portion 3c and the one step-like formed portion 3e continuous to each other, is formed thick.

As a result, as shown in FIG. 5, in the hardened inner layer 3A, which is obtained by performing, on the blank material 32, the above-described closed forging, compression molding or the combined molding thereof, the periphery of the bent corner portion 3f of the plunger member 3 can be formed thick, the stress force to the periphery of the bent corner portion 3f can be reduced, and the durability can be improved.

The application of the working hardness by performing the cold closed forging, compression molding or the combined molding thereof described above can suppress the deformation of the step-like formed portions 3d, 3e of the plunger member 3, particularly, the deformation of the peripheral portion of the bent corner portion 3f, caused by a large deformation stress to expand toward the outside due to a restoring action of the spring 7 or the hydraulic pressure of the pulley oil chamber 5 during the sliding operation of the movable-side pulley half body 22 on the output shaft 1.

Next, raw materials configuring the plunger member 3 according to one embodiment are described.

The plunger member 3 according to one embodiment is configured by using three raw materials that are described as below, for example. The symbol “%” given to each component configuring these raw materials indicates mass %.

First, as a first raw material configuring the plunger member 3 according to one embodiment, a hot rolled steel plate raw material is used, which has a chemical composition containing components of mass % described as below.

C: 0.03 to 0.20%; Si: equal to or less than 0.5%; Mn: 0.10 to 2.0%; P: equal to or less than 0.050%; S: equal to or less than 0.020%; Al: 0.01 to 0.30%; N: equal to or less than 0.060%; and the balance: Fe and incidental impurities

Next, reasons for the chemical component limitations of the hot rolled steel plate raw material according to the above-described first raw material are as the followings.

(C: 0.030 to 0.20%)

C is a necessary element for ensuring the intensity of the hot rolled steel plate raw material. In order to perform its effect, C of 0.030% or more is required. However, as the amount of C becomes large, the press formability is reduced and a crack or breakage during the component molding is easily generated. To prevent this, the amount of C has to be set to be equal to or less than 0.20%. Preferably, the amount of C is equal to or less than 0.15%.

(Si: equal to or less than 0.50%)

Si is added for ensuring the intensity of the hot rolled steel plate raw material. However, Si becomes attached to nitrogen that enters in the steel by the soft nitriding treatment to form nitride. Because a contribution of the Si nitride to the surface hardening is small, an upper limit is set to be equal to or less than 0.5%.

(Mn: 0.10 to 1.80%)

Mn is necessary for ensuring the intensity of the hot rolled steel plate raw material, and further, is a necessary element for preventing a hot rolled crack caused by S remaining in the steel. In order to prevent the crack of the hot rolled hot rolled steel plate raw material caused by S added according to the present invention, Ms of 0.10% or more is required. However, the effect becomes saturated if its amount exceeds 1.80%. For that reason, the upper limit is set to 1.80%.

(P: equal to or less than 0.050%)

Although P is an impurity element that is included when manufacturing the hot rolled steel plate raw material, P is an element that can increase, even with a small amount, the intensity of the hot rolled steel plate raw material. However, if the amount of P exceeding 0.050% is added, the ductility of the hot rolled steel plate raw material is reduced. For that reason, the upper limit of the addition is set to 0.050%.

(S: equal to or less than 0.020%)

S is an impurity element that is included when manufacturing the hot rolled steel plate raw material. The amount exceeding 0.020% becomes the reason that the crack is generated in the hot rolled steel plate raw material during the hot rolling, and also becomes the reason why the ductility of the hot rolled steel plate raw material after annealing is reduced. For that reason, the upper limit is set to 0.020%.

(Al: 0.01 to 0.30%)

Al is necessary as a deoxidizing element to remove oxygen in the molten steel. At that time, it is necessary to add the amount of Al more than the amounts of oxygen and the like for performing a sufficient deoxidation, and it is effective if Al of 0.01% or more is left. However, if its amount exceeds 0.30%, it causes the ductility to be reduced. Therefore, Al is set to 0.02 to 0.30%.

(N: equal to or less than 0.0060%)

Although N is an element to contribute the increase of the intensity of the steel plate by forming the nitride compound, N causes the press workability to be reduced if a large amount of N is contained at the material step of the hot rolled steel plate. N is not necessarily a required element at the material step because the nitride compound can be formed by nitrogen that is supplied from the surface of the member molded by the soft nitriding treatment. For that reason, the amount of N is set to be equal to or less than 0.0060%.

Also, a second raw material configuring the plunger member 3 according to one embodiment is a hot rolled steel plate raw material having a chemical composition containing components of mass % described as below.

C:0.03 to 0.20%; Si: equal to or less than 0.5%; Mn: 0.10 to 2.0%; P: equal to or less than 0.050%; S: equal to or less than 0.020%; Al: 0.01 to 0.30%; N: equal to or less than 0.060%; Nb: 0.008 to 0.09%; and the balance: Fe and incidental impurities

Therefore, the second raw material is configured to further contain Nb of 0.008 to 0.09% compared to the above-described first raw material, and have Fe and the incidental impurities as the balance.

(Nb: 0.008 to 0.09%)

Nb contained in the second raw material is a necessary element that is to be combined with C to generate NbC for maintaining the working hardening according to a recrystallization suppression function of working components.

The inventors of the present application investigated the presence/absence of the hardness reduction when press working and performing the soft nitriding treatment on the hot rolled steel plate raw materials respectively having various amounts of Nb. As a result, the inventors of the present application found that the effect of maintaining the hardness is significant by performing the press working according to the deep-drawing molding, and compression molding, closed forging or the combined molding thereof on the hot rolled steel plate raw materials having Nb of 0.008% or more according to the present invention.

However, if the amount of Nb exceeds 0.09%, the anisotropy becomes large and this may have an influence on the shape accuracy of the components. According to the reason, the amount of Nb is set to 0.008 to 0.09%.

Also, a third raw material described below is a hot rolled steel plate raw material that is configured to have a chemical composition further containing components of mass % described as below compared to the above-described second raw material and have Fe and the incidental impurities as the balance.

Ti: equal to or less than 0.09%; Cu: equal to or less than 0.1%; Ni: equal to or less than 0.10%; Cr: equal to or less than 0.02%; Mo: equal to or less than 0.02%; V: equal to or less than 0.02%; and B: 0.05%

Reasons why the third raw material is configured to contain the above-described chemical composition are as the followings.

(Ti: equal to or less than 0.09%)

That is, the third raw material as the hot rolled steel plate can contain Ti of 0.09% or less if necessary for ensuring the intensity. In order to avoid the anisotropy issue, the upper limit is set to 0.09%.

(Cu: equal to or less than 0.10%)

In addition, the third raw material can contain Cu of 0.10% or less if necessary for ensuring the intensity. Cu is deposited in the hot rolled steel plate raw material at the nitriding treatment temperature and has an intensity-increasing effect. However, because Cu becomes the reason to cause a crack of the hot rolled steel plate raw material when manufacturing the hot rolled steel plate by hot rolling, Ni is also needed to be added at the same time and this becomes the reason of material cost increase. For that reason, the upper limit is set to 0.10%.

(Ni: equal to or less than 0.10%)

Also, the third raw material can exactly perform the crack prevention function during the hot rolling by adding Ni. The amount of Ni to be added is preferably 0.5 of the amount of Cu or more, and more preferably, is equivalent to the amount of Cu. Because it may become to be the reason of material cost increase, the upper limit is set to 0.10%.

(Cr: equal to or less than 0.02%)

Also, the third raw material can contain Cr of 0.02% or less if necessary for ensuring the intensity. In order to suppress the material cost increase, the upper limit is set to 0.02%.

(Mo: equal to or less than 0.02%)

Also, the third raw material can contain Mo of 0.02% or less if necessary for ensuring the intensity. In order to suppress the material cost increase, the upper limit is set to 0.02%.

(V: equal to or less than 0.02%)

Also, the third raw material can contain V of 0.02% or less if necessary for ensuring the intensity. In order to suppress the material cost increase, the upper limit is set to 0.02%.

(Ca: equal to or less than 0.01%)

Also, S included in the third raw material is combined with Mn to form a deposit consisting of MnS. This MnS extends due to the hot rolling and may become to be the reason of the press crack. By adding Ca, CaS that hardly extends due to the hot rolling can be formed. Although Ca is added as necessary, its effect is saturated with the amount of 0.01%; accordingly, the upper limit is set to 0.010%.

(B: equal to or less than 0.0050%)

In addition, B contained in the third raw material has an effect of preventing the solid-dissolved nitrogen from excessively remaining by attaching to N in the steel. For that reason, B is added if necessary. However, if the amount of B exceeds 0.0050%, the performance of the mechanical property is reduced and the anisotropy becomes large. For that reason, the upper limit is set to 0.0050%.

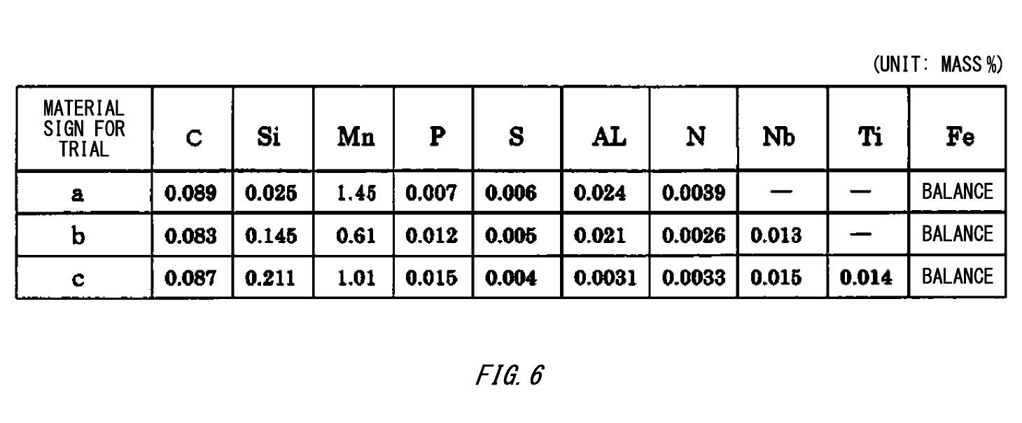

The inventors of the present application conducted various experiments by manufacturing the plunger member 3 by respectively using materials a to c for trial, which are configured with the hot rolled steel plate raw materials containing the components of mass % shown in FIG. 6 among the above-described first to third raw materials.

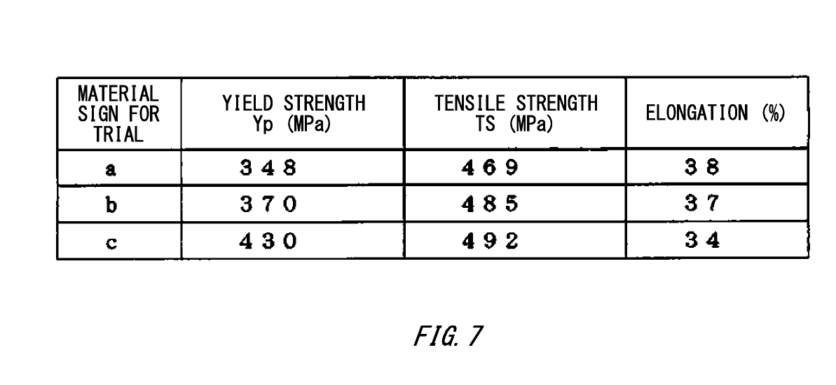

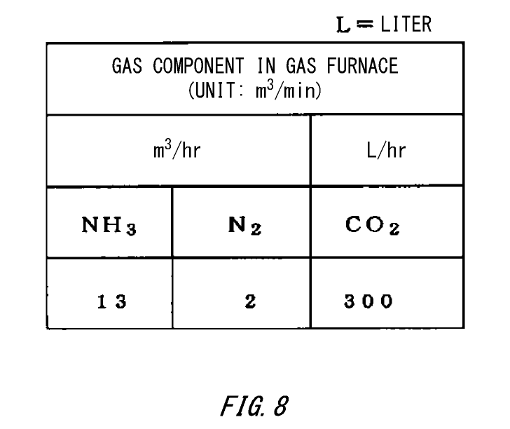

The various experiments were conducted by manufacturing the plunger member 3 by respectively using the hot rolled steel plate raw materials that have a plate thickness of 5.6 mm and have mechanical properties such as yield strength YS (MPa), tensile strength TS (MPa) and elongation EL (%) respectively shown in FIG. 7, as the materials a to c for trial, performing molding according to the above-described press molding, and after that, performing the soft nitriding treatment within the furnace having the gas composition shown in FIG. 8.

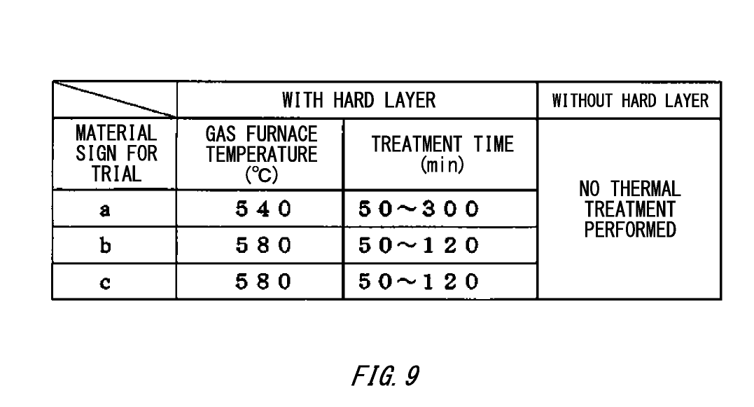

Also, the above-described soft nitriding treatment was performed at the gas furnace temperature and for the treatment time shown in FIG. 9. In addition, the plunger member 3, which was manufactured only by the above-described press molding without performing the soft nitriding treatment and accordingly had no hardened surface layer, was prepared as a sample for comparison.

First, an abrasion test was conducted. This abrasion test was conducted by fixing the spring 7 by a holder (not shown), applying a surface pressure of 10 MPa according to the spring 7 on an inner surface of the spring seating portion 3d of the plunger member 3 (the inner side of the portion A of FIG. 2), and subsequently, rotating the plunger member 3 for one million times, and after that, measuring an abrasion amount of the inner side of the portion of sign A of the spring seating portion 3d.

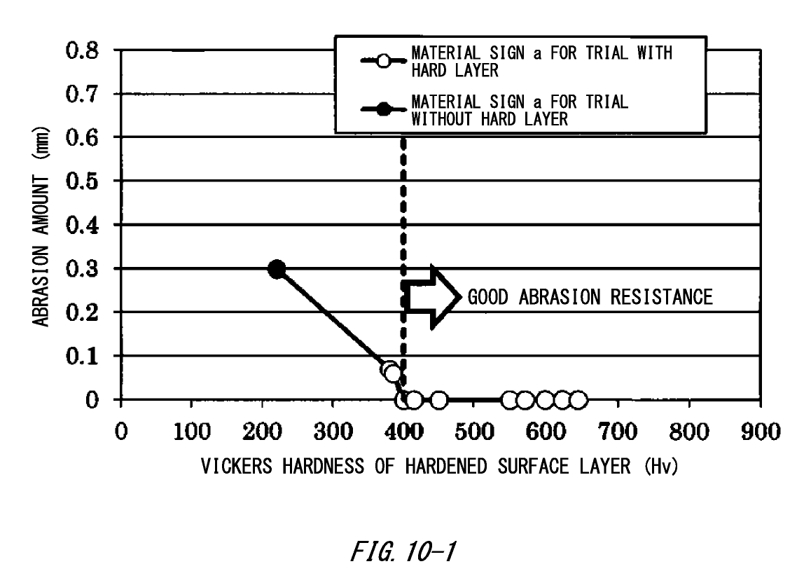

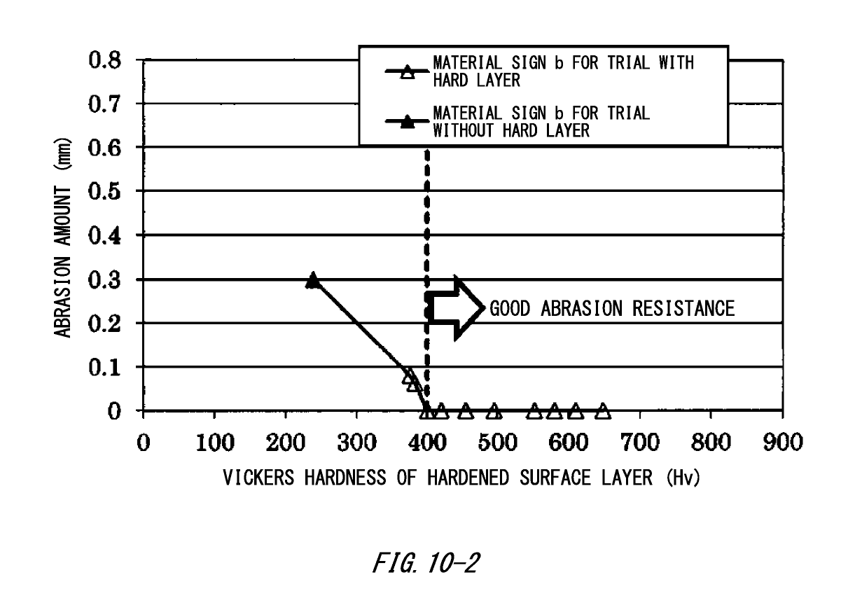

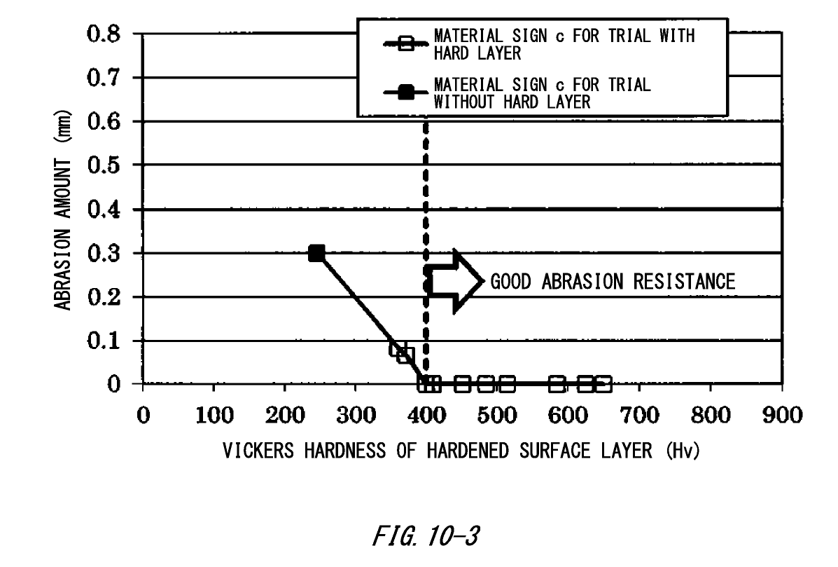

As such an abrasion test result, first, the abrasion amount (mm) of the spring seating portion 3d and the Vickers hardness (Hv) of the hardened surface layer 3B for each of the materials a to c for trial is respectively shown in FIG. 10-1, FIG. 10-2, and FIG. 10-3. FIG. 10-1, FIG. 10-2, and FIG. 10-3 show that in a case of “with hard layer”, the depth of the hard layer indicates the data in a case of 4 μm or more, and the hardness of the hardened surface layer 3B being 400 Hv or more is required for having the abrasion resistance.

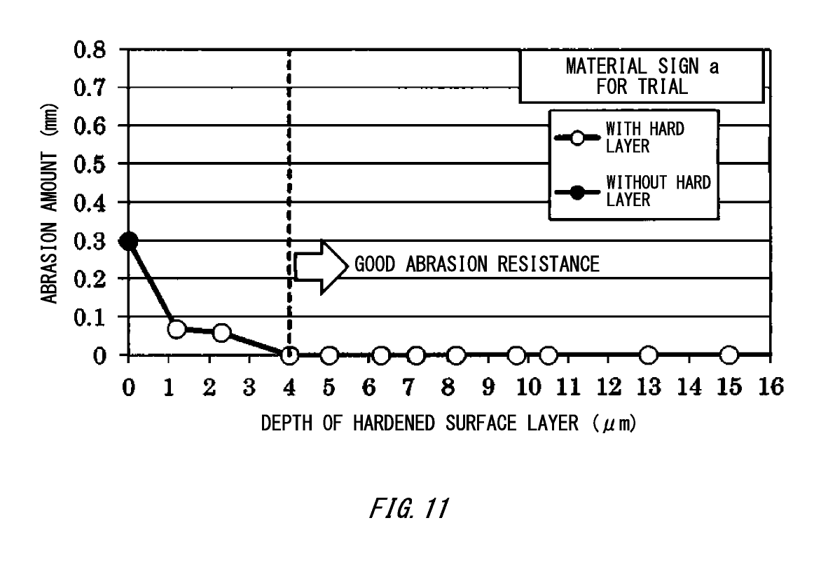

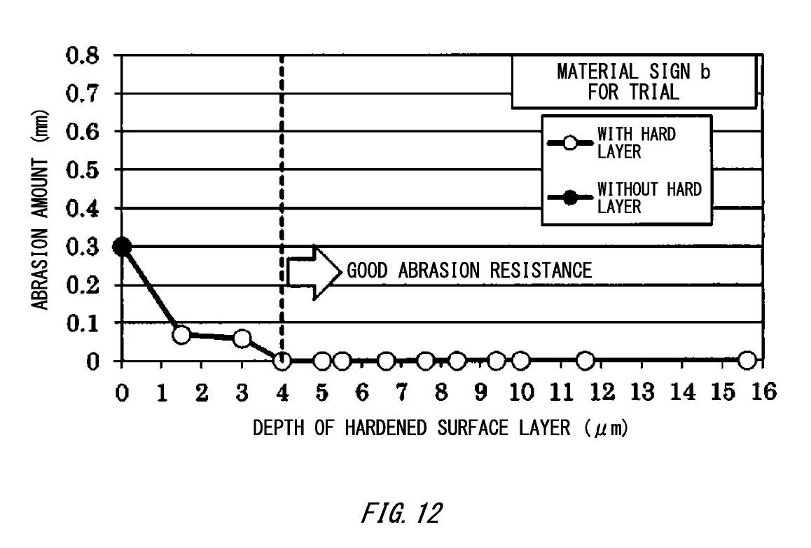

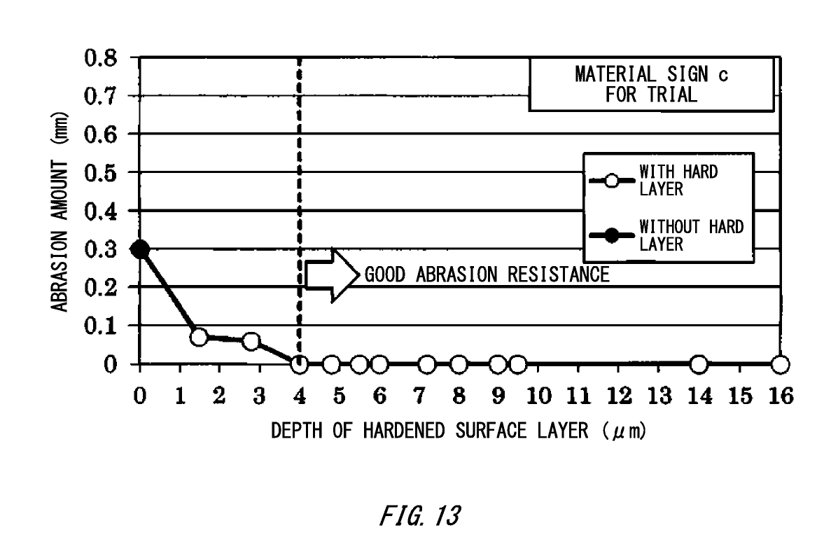

Also, as the above-described abrasion test result, the spring seating portion 3d of each of the materials a to c for trial showed the abrasion amount (mm) relative to the depth (μm) of the hardened surface layer 3B as respectively shown in FIG. 11 to FIG. 13.

As shown in FIG. 11 to FIG. 13, the plunger member 3 in which the hardened surface layer 3B has the depth being less than 4 μm has the larger abrasion amount (mm) according to the spring 7 in the spring seating portion 3d.

On the other hand, almost no abrasion can be measured at the spring seating portion 3d of the plunger member 3 configured to have the hardened surface layer 3B formed having the depth of 4 μm or more and the hardness of 400 Hv or more in Vickers hardness by performing the soft nitriding treatment. The spring 7 seating on the spring seating portion 3d also has high hardness. Therefore, in the abrasion test in which an actual vehicle running is assumed, if the hardened surface layer 3B is thin, a crack is easily generated in the hardened surface layer 3B by the surface pressure received from the spring 7. If the spring seating portion 3b repeatedly continues contacting the spring 7 in a thrust direction, the hardened surface layer 3B is removed from the crack in the hardened surface layer 3B as a starting point. If the hardened surface layer 3B is removed, the progress of the abrasion becomes rapid, and product functions cannot be satisfied. Accordingly, to prevent the hardened surface layer 3B from being removed, it is preferable that the thickness of the hardened surface layer 3B is equal to or greater than 4 μm.

However, if the Vickers hardness is less than 400 Hv, the hardened surface layer 3B is peeled and the abrasion in the inner side is generated.

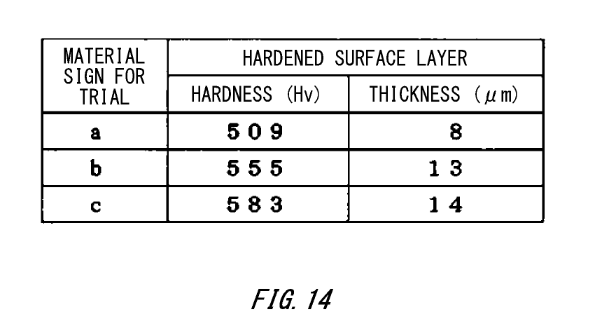

Furthermore, FIG. 14 shows a comparison of the Vickers hardness (Hv) and the thickness (μm) of the hardened surface layer 3B of the spring seating portion 3d of the blank material 3.

Next, the inventors of the present application manufactured, by using the blank materials 32 respectively consisting of the materials a to c for trial which are the hot rolled steel plate raw materials having the compositions shown in FIG. 6 and the mechanical properties shown in FIG. 7, trial products of the plunger member 3 in a case of configuring the plunger member 3 to have the hardened inner layer 3A according to the cold press molding by performing the deep-drawing molding, and closed forging, compression molding or the combined molding thereof as shown in FIG. 3-3, in addition to the deep-drawing molding as shown in FIG. 3-2.

The plate thickness size of the plunger member 3 according to the trial products was increased by 2% to 80% relative to the raw material plate thickness of the blank material 32.

For the trial products configured as the above, under the conditions shown in FIG. 8 and FIG. 9, the plunger member 3 with the hardened surface layer 3B formed therein was manufactured for trial by performing the soft nitriding treatment. In this case, the soft nitriding treatment time shown in FIG. 9 was set as the followings: the soft nitriding treatment time for the material sign a was set to 200 minutes (min), and the soft nitriding treatment time for either the material sign b or the material sign c was set to 100 minutes (min).

As a result, as shown in FIGS. 1 to 4, the plunger member 3 respectively made from the materials a to c for trial has the hardened surface layer 3B formed by the soft nitriding treatment, which can be configured to be the component having the thickness of 8 to 14 μm on the front and back sides and having the hardness of 509 to 583 Hv in Vickers hardness.

Also, the hardened inner layer 3A formed inside the front and back sides of the hardened surface layer 3B of the plunger member 3 had the hardness of 180 Hv or more in Vickers hardness.

It should be noted that to form the hardened surface layer 3B by soft nitriding, the conditions for the soft nitriding treatment gas are not limited to those described in the conditions for the soft nitriding treatment gas shown in FIG. 8. For example, the soft nitriding treatment can be performed within a range of 5 to 13 m³/hr on NH₃, 1 to 5 m³/hr on N₂, and the like, and further, gas with a different composition as an alternative to CO₂ also can be injected thereinto.

Next, the inventors of the present application conducted an experiment by injecting oil into the pulley oil chamber 5 after attaching a strain gage to the bent corner portion 3f of the plunger member configured in this way, and then applying a hydraulic pressure of 9 MPa to this oil.

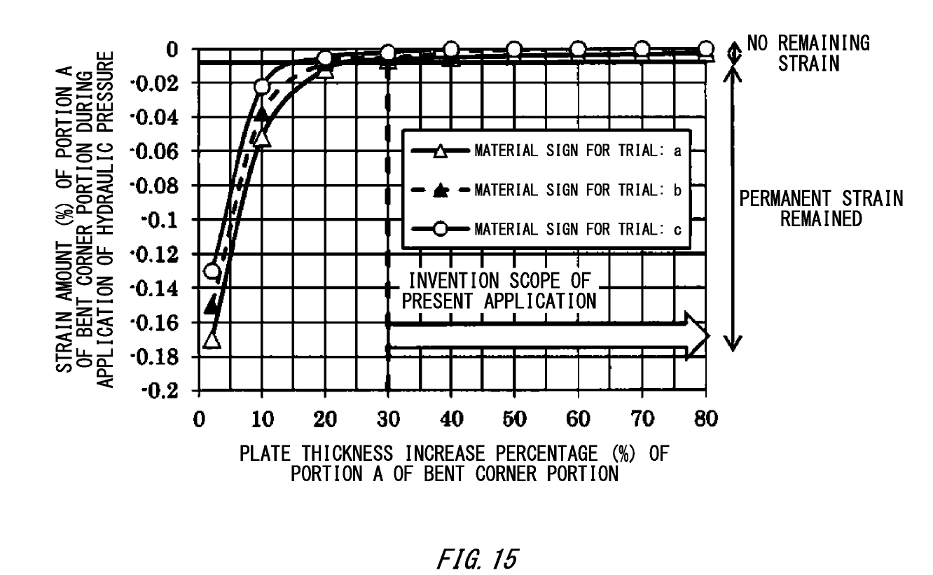

As a result, a relation between the plate thickness of the bent corner portion 3f (corresponding to the “portion A” of FIG. 2) of the plunger member 3 and the strain amount measured by the strain gage is as shown in FIG. 15.

In addition, the presence/absence of the remaining permanently strain of the plunger member 3 when unloading the above-described hydraulic pressure is as described on the right side out of the frame in FIG. 15.

Therefore, by making the plate thickness of the bent corner portion 3f (corresponding to the “portion A” of FIG. 2) of the plunger member 3 thicker by 30% or more relative to the plate thickness of the raw material of the materials a to c for trial, the strain amount of the bent corner portion 3f becomes extremely small. Furthermore, when unloading the hydraulic pressure of the pulley oil chamber 5, the permanent strain can be prevented from remaining (refer to the description on the right side out of the column in FIG. 15).

Subsequently, the inventors of the present application considered the hardness of the hardened inner layer 3A of the plunger member 3 at which the permanent strain can be prevented from remaining when performing the deep-drawing molding by applying the hydraulic pressure of 9 MPa thereto in molding the plunger member 3.

That is, the inventors of the present application manufactured for trial a plurality of trial products having the bent corner portion 3f (corresponding to the “portion A” of FIG. 2) with the plate thickness that is the thickness being 60% of the plate thickness of the above-described raw material by using the raw material of hot rolled steel plate raw materials described in the materials a to c for trial shown in FIG. 6, and performing, under the changed molding conditions as well, the press molding according to the closed forging, compression molding, or the combined molding thereof after the deep-drawing molding when manufacturing the plunger member 3 by cold press molding.

As a result, the Vickers hardness of the hardened inner layer 3A of the plunger member 3 immediately after the above-described press molding was respectively 255 Hv for the material a for trial, 261 Hv for the material b for trial, and 265 Hv for the material c for trial.

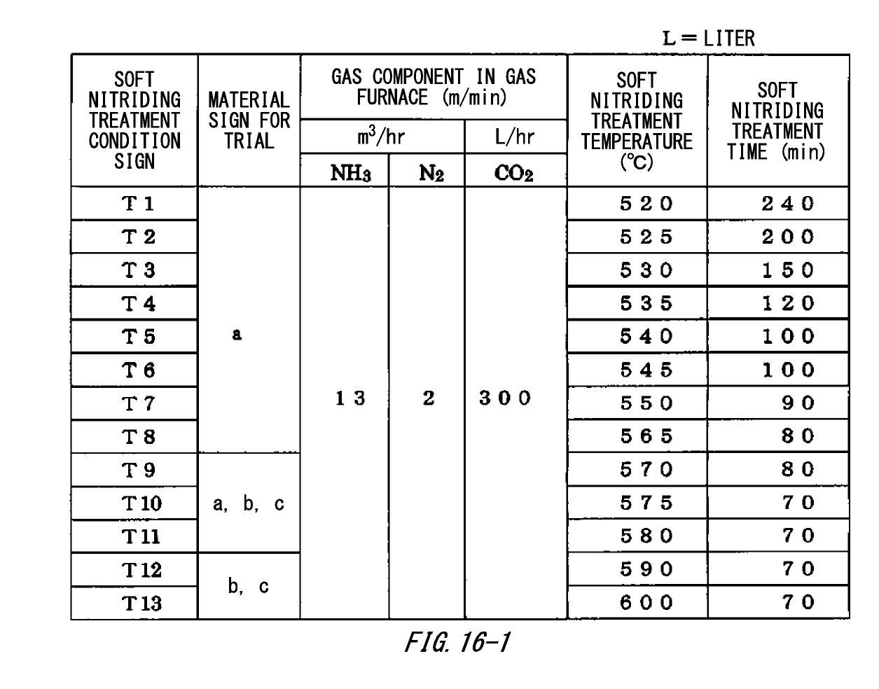

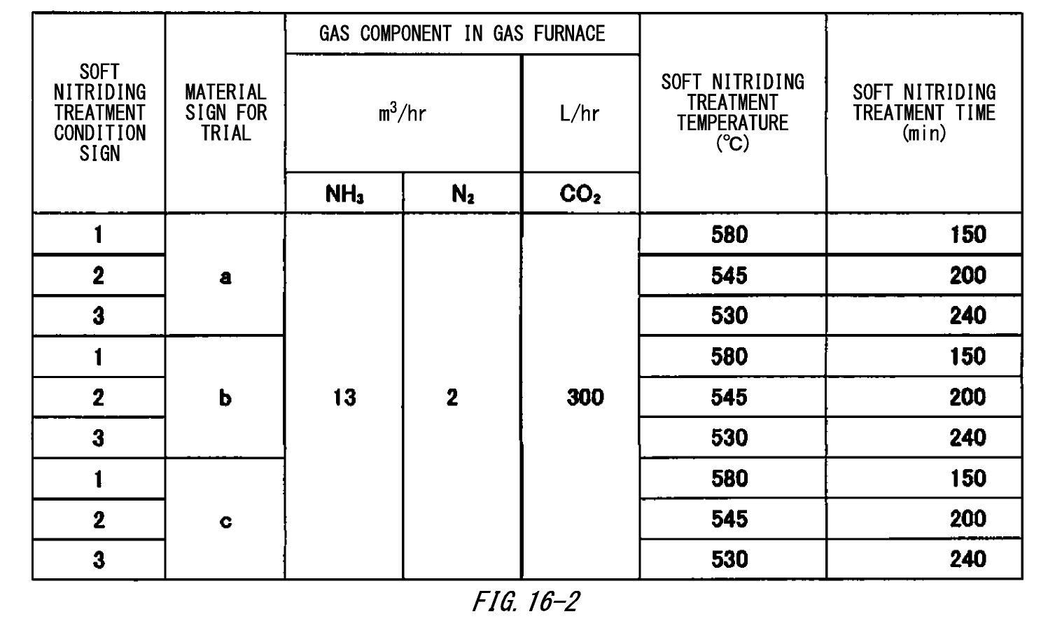

Here, subsequently, the inventors of the present application first manufactured the trial products having the hardened inner layer 3A of the bent corner portion 3f (corresponding to the “portion A” of FIG. 2) at various hardness by performing the soft nitriding treatment shown in FIG. 16-1 on the plunger member 3 manufactured for trial by respectively using the materials a, b, c for trial.

In any of the plunger members 3 according to the trial products, the hardened surface layer 3B having a thickness of 8 to 20 μm on each of both front and back sides and having the hardness of 450 to 650 Hv in Vickers hardness, and the hardened inner layer 3A having the hardness of 180 to 270 Hv in Vickers hardness have been formed.

For the trial products of the plunger members 3 configured in this way, after the strain gage was attached to the bent corner portion 3f (corresponding to the “portion A” of FIG. 2), oil was injected into the pulley oil chamber 5, and then a pressure of 9 MPa was applied to this oil for trial.

As a result, for the plunger member 3 according to the trial products by respectively using the above-described materials a, b, c for trial described above, the relation between the Vickers hardness of the hardened inner layer 3A in the bent corner portion 3f (the “portion A” of FIG. 2) and the strain amount measured by the above-described strain gage became to those respectively shown in FIG. 17-1 to FIG. 17-3.

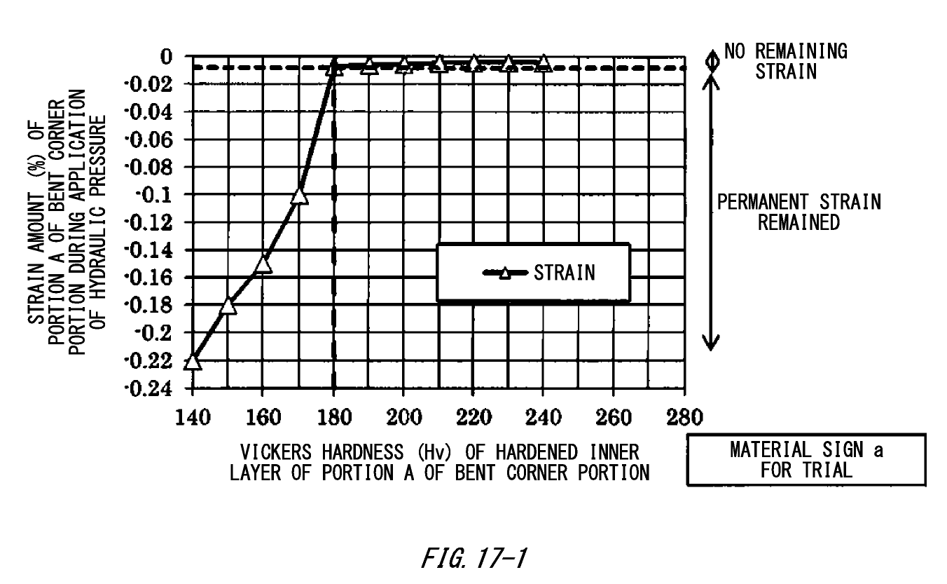

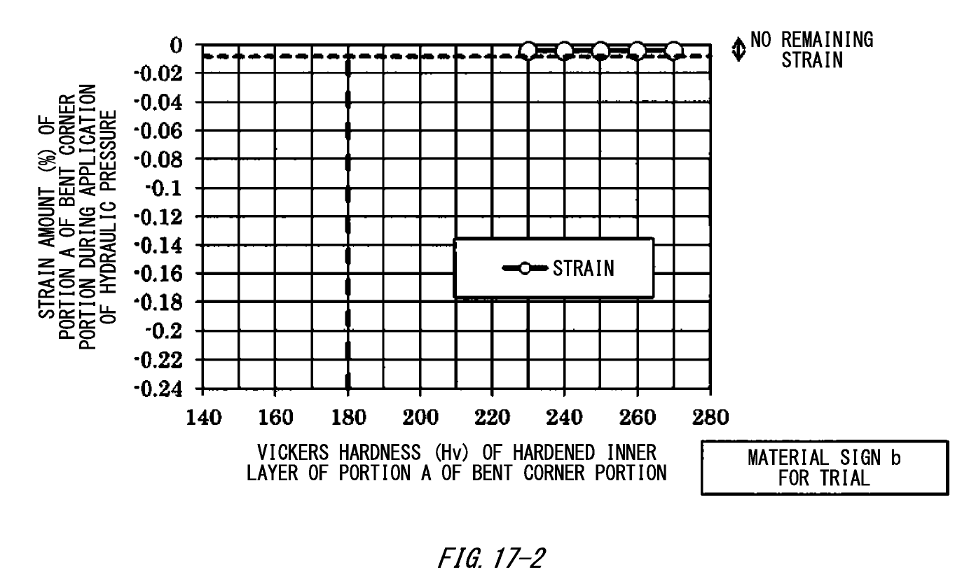

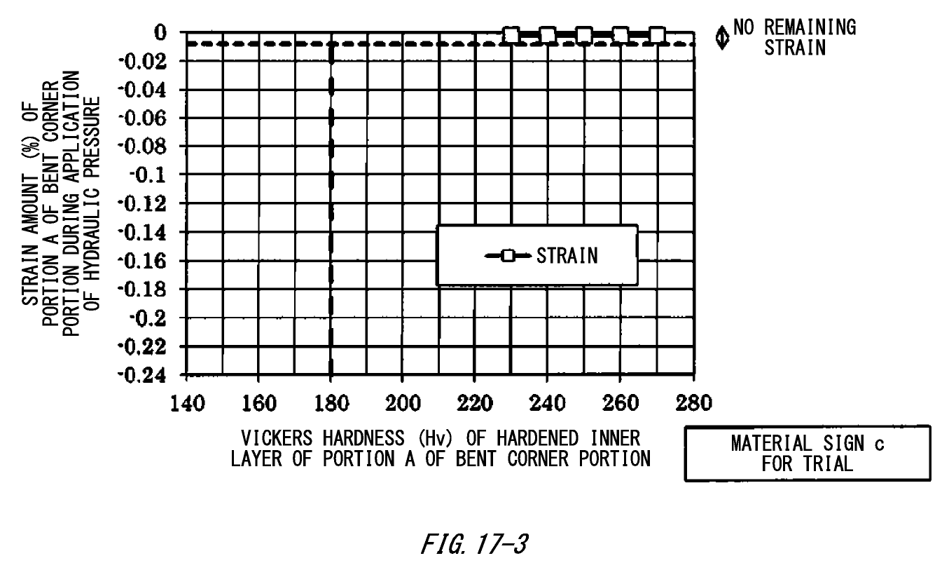

According to the description of FIG. 17-1, if the hardness of the hardened inner layer 3A in the bent corner portion 3f (the “portion A” of FIG. 2) is less than 180 Hv, a large strain is generated on the minus side.

On the other hand, by making the hardness of the hardened inner layer 3A in the bent corner portion 3f (the “portion A” of FIG. 2) equal to or greater than 180 Hv, the strain amount is reduced if the hydraulic pressure is applied to the pulley oil chamber 5.

It should be noted that as results of similar investigations using the material signs b, c, as respectively shown in FIG. 17-2 and FIG. 17-3, the hardness of the hardened inner layer 3A in the bent corner portion 3f (corresponding to the “portion A” of FIG. 2) becomes to be equal to or greater than 180 Hv under all of the thermal treatment conditions, and the strain amount in a case where the hydraulic pressure was applied to the pulley oil chamber 5 becomes extremely small.

Then, as an examination result of the presence/absence of the remaining permanent strain of the plunger member 3 when unloading the hydraulic pressure of the pulley oil chamber 5, it was also found from any of FIG. 17-1 to FIG. 17-3 that the permanent strain can be prevented from remaining by making the Vickers hardness of the bent corner portion 3f (corresponding to the “portion A” of FIG. 2) equal to or greater than 180 Hv.

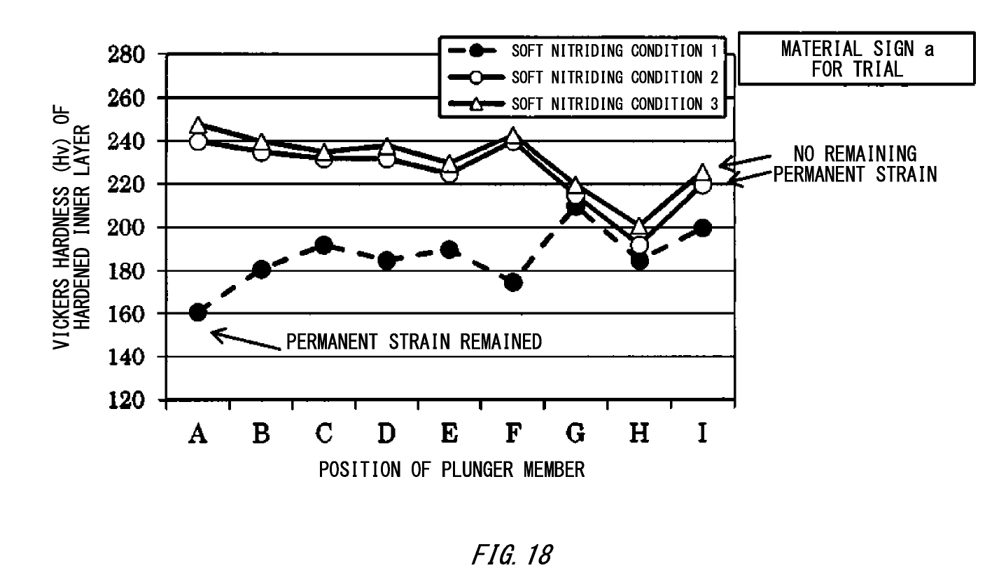

Next, FIG. 18 shows the hardness of the hardened inner layer 3A of the parts A to I shown in FIG. 2 of the plunger member 3 according to the trial product using the material a for trial in a case where the soft nitriding treatment condition shown in FIG. 16-2 was applied thereto.

According to FIG. 18, by performing the soft nitriding condition 2 or 3 shown in FIG. 16-2, the hardened inner layer 3A of the portion A to portion I shows the hardness of 18 Hv or more in Vickers hardness.

According to the above, it was found that by performing the soft nitriding condition 2 or 3, all parts including the portion A in the plunger member 3 according to the trial product using the material a for trial can include the hardened inner layer 3A having the hardness of 18 Hv or more, and the permanent strain can be prevented from being generated even if the hydraulic pressure of 9 MPa was applied thereto.

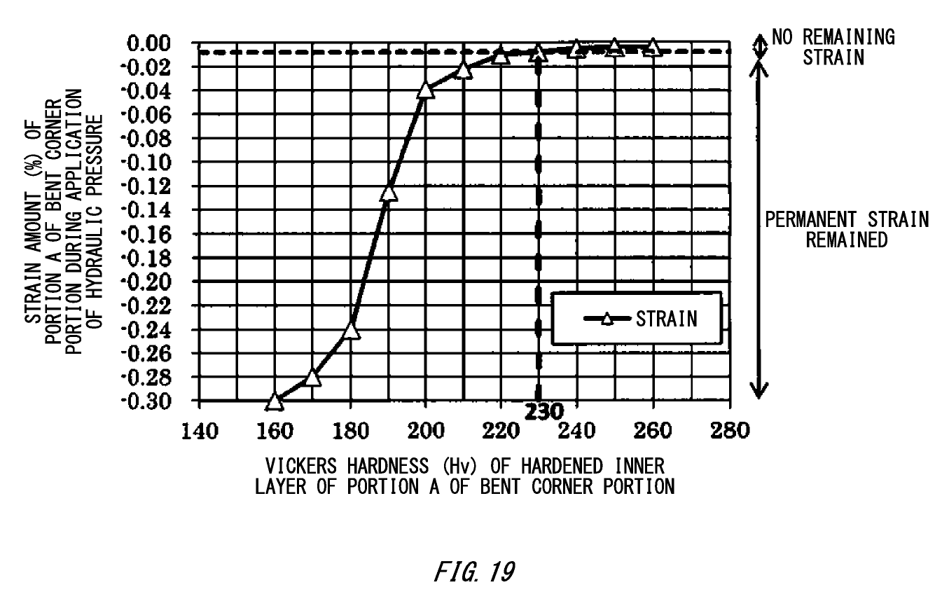

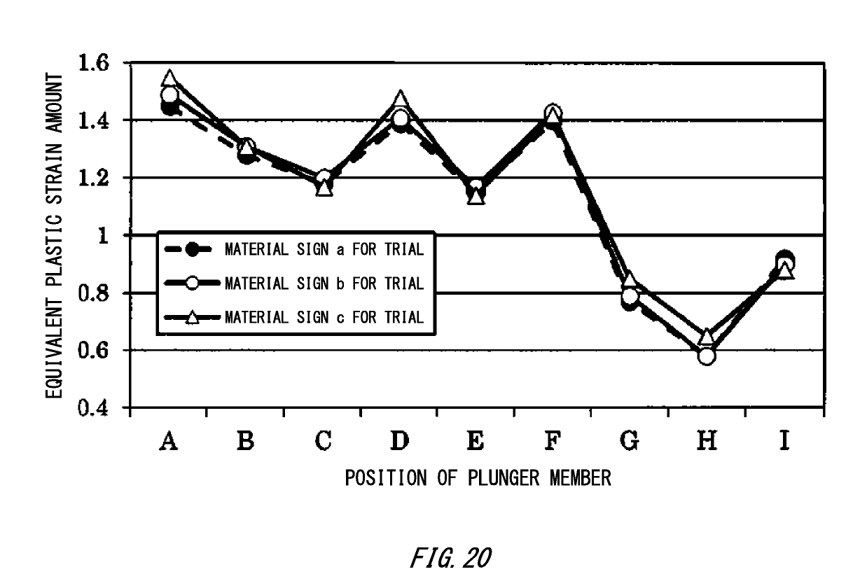

FIG. 19 shows a relation between the Vickers hardness (Hv) of the hardened inner layer 3A of the portion A of the bent corner portion and the strain amount (%) of the portion A of the bent corner portion during the application of the hydraulic pressure. Also, FIG. 20 represents the equivalent plastic strain amount of the portions A to I of FIG. 2 of the plunger member 3 as the trial product respectively using the materials a to c for trial.

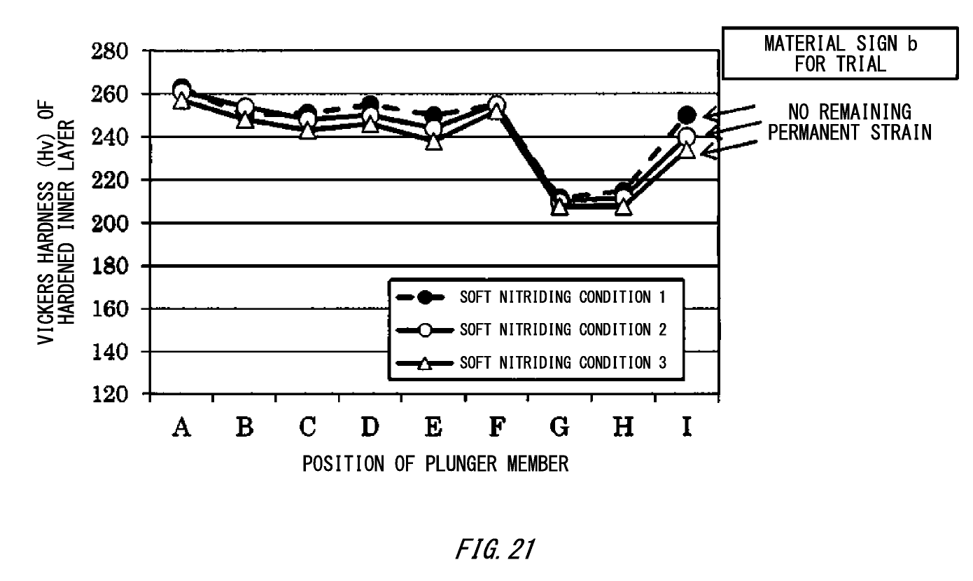

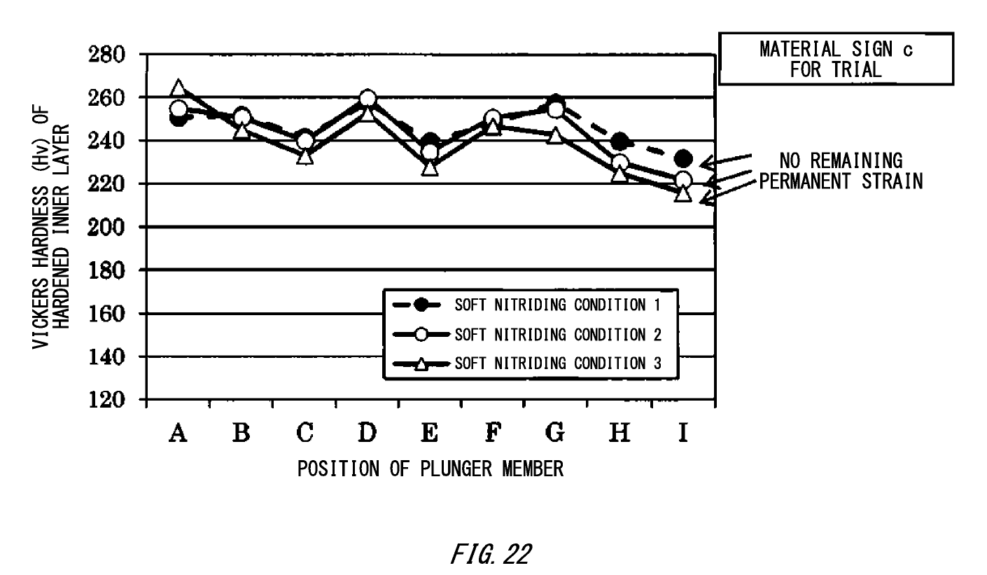

Similarly, FIG. 21 and FIG. 22 show the hardness of the hardened inner layer 3A of the parts A to I shown in FIG. 2 of the plunger member 3 in a case where the soft nitriding treatment condition shown in FIG. 16-2 was respectively applied to the plunger members 3 respectively using the materials being the materials b, c for trial.

According to FIG. 21 and FIG. 22, it is shown that in the plunger member 3 respectively using the materials being the materials b, c for trial, the hardened inner layer 3A of the portions A to I of FIG. 2 has the hardness of 18 Hv or more in Vickers hardness under any condition of the soft nitriding treatment conditions 1 to 3 of FIG. 16-2.

According to the above, it was found that in the plunger member 3 according to the trial products respectively using the material signs b, c, by performing any of the soft nitriding conditions 1 to 3, the hardened inner layer 3A in all parts of the portions A to I shown in FIG. 2 can have the hardness of 18 Hv or more and the permanent strain can be prevented from being generated even if the hydraulic pressured of 9 MPa was applied thereto.

It should be noted that to form the hardened surface layer by soft nitriding, the soft nitriding treatment gas conditions are not limited to those described in the soft nitriding treatment gas conditions shown in FIG. 16-1 and FIG. 16-2. For example, the soft nitriding treatment may be performed within a range of 5 to 13 m³/hr on NH₃, 1 to 5 m³/hr on N₂, and the like, and further, gas with a different composition as an alternative to CO₂ also can be injected thereinto.

The inventors of the present application obtaining such a result investigated the hardness, for withstanding further higher hydraulic pressure, of the hardened inner layer 3A of the plunger member 3 according to the trial product using the material a for trial.

That is, the inventors of the present application manufactured a plurality of the plunger members 3 having the above-described portion A with the plate thickness that is the thickness increased by 70% relative to the plate thickness of the material a for trial by performing, under the changed conditions, the press molding according to the closed forging, compression molding or the combined molding thereof after the deep-drawing molding when manufacturing the plunger member 3 by press molding. As a result, the Vickers hardness of the hardened inner layer of the portion A was 265 Hv.

Then, the inventors of the present application manufactured for trial the trial products having the portion A at various hardness by performing the soft nitriding treatment on the plurality of the plunger members 3 at different processing temperatures and for treatment time differed from each other.

As a result, in the plunger members 3 according to these trial products, the hardened surface layer 3B having the thickness of 8 to 20 μm on both front and back sides and having the hardness of 450 to 650 Hv in Vickers hardness, and the hardened inner layer 3A having the hardness of 180 to 270 Hv in Vickers hardness can be obtained.

The inventors of the present application conducted experiments for trial by attaching the strain gage to the portion A of the plunger member 3 configured to having such a hardened surface layer 3B and such a hardened inner layer 3A, and after that, applying a hydraulic pressure of 10 PMa to the oil injected into the pulley oil chamber 5.

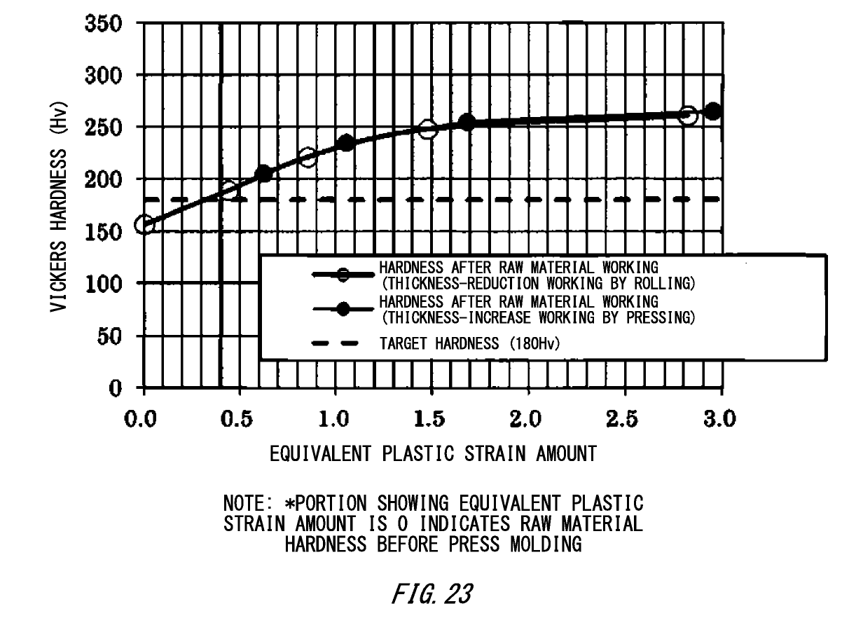

FIG. 23 shows a relation between the Vickers hardness and the equivalent plastic strain amount, which is measured by the strain gage, of the above-described portion A of the plunger member according to the experiment result.

According to FIG. 23, it was known that if the Vickers hardness of the hardened inner layer 3A in the above-described portion A of the plunger member 3 is equal to or greater than 230 Hv, the permanent deformation of the portion A can be prevented from being generated even if the hydraulic pressure of 10 MPa was applied thereto.

It should be noted that, as shown in FIG. 23, if the equivalent plastic strain amount can be set to 1.0 or more, the Vickers hardness can be set to 230 Hv or more.

Then, when performing the molding on the plunger member 3 by the press machine according to the closed forging, compression molding or the combined molding thereof, if the equivalent plastic strain amount of 1.0 or more can be applied to the portion A of the plunger member 3, the hardness of the portion A equal to or greater than 230 Hv can be ensured.

Accordingly, even if the further higher hydraulic pressure being 10 MPa was applied thereto, the high-pressure-resistant plunger member 3 can be manufactured, which can prevent the permanent strain from remaining.

Next, the Vickers hardness of the hardened inner layer 3A in each part A to I shown in FIG. 2 of the plunger member 3 in a case where the material signs b, c shown in FIG. 6 were used as the materials for trial respectively configuring the plunger member 3 was measured, and results respectively shown in FIG. 21 and FIG. 22 were obtained.

Therefore, as shown in FIG. 21 and FIG. 22, even if the plunger member 3 was configured by using the material sign b or c, when the Vickers hardness of the portion A to portion I of the plunger member 3 is 230 Hv or more, the permanent deformation in the portion A to portion I can be prevented from being generated even if the hydraulic pressure of 10 MPa was applied thereto.

Next, the inventors of the present application investigated the reasons why the equivalent plastic strain amount of the plunger member 3 is set to 0.4 or more.

For this reason, the inventors of the present application manufactured as the plunger member 3 by using the material for trial being the hot rolled steel plate that still has the composition shown in FIG. 6, and has the tensile strength TS (MPa) shown in FIG. 7, and has the material thickness of 5.6 mm.

For the plunger member 3 manufactured by such a material for trial, the inventors of the present application investigated the relation between the hardness increase by the press working and the working level, and found that the hardness can be set to 18 Hv or more, 18 Hv being a target value that satisfies the intensity of the plunger member 3, by working so as to make the equivalent plastic strain amount be 0.4 or more (refer to FIG. 23).

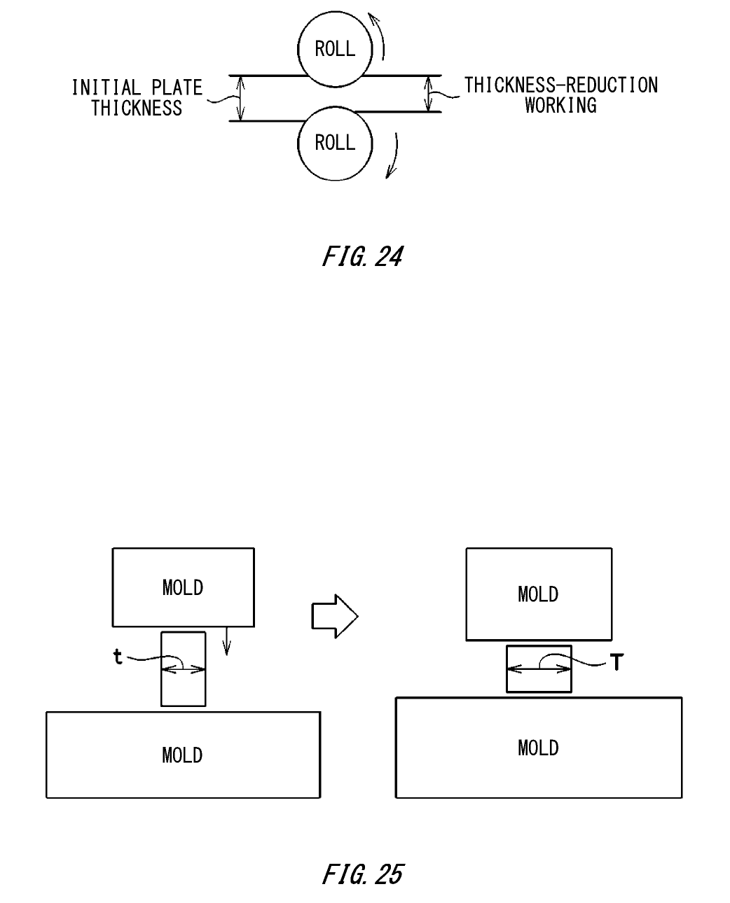

The above-described investigation was performed by a method of thickness-reduction working on the hot rolling steel plate, which is the material for trial, between two rolls at room temperature as shown in FIG. 24, and by a manner of performing thickness-increase working according to the compression-molding working by a press machine, as shown in FIG. 25, so as to make an initial plate thickness t be T (T>t).

According to the investigation, it was found that because the working hardness is correlated with the equivalent plastic strain amount without depending on the working means, if the deep-drawing molding, and closed forging, compression molding or the combined molding thereof was performed, the target value, 18 Hv, of the Vickers hardness can be achieved by making the equivalent plastic strain amount be 0.4 or more.

As described above, the plunger member 3 in any of the embodiments is configured by performing the cold press molding on the blank material 32 according to the deep-drawing molding, and closed forging, compression molding or the combined molding thereof. The thickness of the bent corner portion 3f, which makes the sleeve portion 3c and the step-like formed portion (the spring seating portion) 3d continuous to each other, is increased by 30% or more relative to the thickness of the blank material 32. Furthermore, the hardened surface layer 3B is formed by performing the soft nitriding treatment on both of the entire front and back sides of the plunger member 3. Accordingly, even if the hardened surface layer 3B was formed by performing the soft nitriding treatment, the softening phenomenon due to the dislocation generated on the hardened inner layer 3A existing in the inner side than the hardened surface layer 3B during the soft nitriding treatment can be suppressed, and the tough and inexpensive plunger member 3 can be provided.

The plunger member 3 according to any of the above-described embodiments is configured to have the hardened surface layer 3B that has the thickness of 4 μm or more relative to both of the outermost and the backmost surfaces of the plunger member 3. Therefore, the hardened inner layer 3A in the bent corner portion 3f after the soft nitriding treatment is configured to have the hardness of 18 Hv or more in Vickers hardness. Accordingly, the force causing the bent corner portion 3f to expand outward due to the hydraulic force of the pulley oil chamber 5 can be suppressed, and the abrasion resistance of the spring seating portion 3d against the biasing force according to the spring 7 can be improved.

Also, according to any of the above-described embodiments, by configuring the entire plunger member 3 to be formed having the equivalent plastic strain amount of 0.4 or more, the hardened inner layer 3A of the plunger member 3 is sufficiently hardened. Accordingly, the softening phenomenon of the hardened inner layer 3A can be suppressed even if the hardened surface layer 3B is formed by applying the appropriate soft nitriding treatment condition thereto.

Furthermore, in manufacturing the plunger member 3 relatively small as the press-molded article by press-molding working, the strain amount of the entire plunger member 3 is set to 0.4 or more. Accordingly, it was advantageous when performing the thickness-increase working on the bent corner portion 3f by deep-drawing molding, and closed forging, compression molding or the combined molding thereof.

Also, according to any of the above-described embodiments, the equivalent plastic strain amount of 1.0 or more is applied to the bent corner portion 3f that makes the sleeve portion 3c and the step-like formed portion (the spring seating portion) 3d continuous to each other. Accordingly, in particular, in the bent corner portion 3f, the hard portion according to the hardened inner layer 3A can be maintained, the outward-expanding force due to the hydraulic force of the pulley oil chamber 5 can be suppressed, and the abrasion resistance of the spring seating portion 3d against the biasing force according to the spring 7 can be improved.

Further, according to any of the above-described embodiments, the hardened inner layer 3A existing in the inner layer portion than the hardened surface layer 3B of the plunger member 3 is formed being of 18 Hv or more in Vickers hardness. Accordingly, the force causing the bent corner portion 3f to expand outward due to the hydraulic force of the pulley oil chamber 5 can be suppressed, and the abrasion resistance of the spring seating portion 3d against the biasing force according to the spring 7 can be improved.

In any of the above-described embodiments, the case applied to the plunger member 3 on the output shaft 1 side in the belt type automatically continuously variable transmission was described. However, the present invention is not limited to this and also can be applied to the plunger member on the input shaft side.

### INDUSTRIAL APPLICABILITY

According to the present invention described above, the tough and inexpensive plunger member in which a predetermined hardness of the hardened inner layer is ensured can be obtained without reducing the hardness of the hardened inner layer obtained by the deep-drawing molding working even if the soft nitriding treatment was performed within the nitriding treatment tank set at high temperature; therefore, it can be said that the present invention is suitable for the plunger member or the like which is fixed to a shaft so as to face a movable-side pulley half body in a belt type continuously variable transmission to define a pulley oil chamber.

### EXPLANATION OF REFERENCES

1 . . . output shaft (shaft), 2 . . . driven pulley (pulley), 21 . . . fixed-side pulley half body, 22 . . . movable-side pulley half body, 3 . . . plunger member, 3A . . . hardened inner layer, 3B . . . hardened surface layer, 3b . . . expanding flange portion, 3c . . . sleeve portion, 3d . . . step-like formed portion (spring seating stair portion), 3e . . . step-like formed portion, 3f . . . bent corner portion, 5 . . . pulley oil chamber, 6 . . . canceller oil chamber

What is claimed is:

1. A plunger member used for a belt type continuously variable transmission, wherein
the plunger member is fixed to a shaft so as to face a movable-side pulley half body configuring a pulley together with a fixed-side pulley half body in the belt type continuously variable transmission to define an oil chamber formed by a cylinder member into a pulley oil chamber and a canceller oil chamber,
the plunger member comprising:
an expanding flange portion having a large diameter, the expanding flange portion formed on one end side by press molding a blank material, the expanding flange portion slidably abutting on the cylinder member;
a sleeve portion having a small diameter, the sleeve portion formed on the other end side, the sleeve portion fit and fixed to the shaft; and
one or more step-like formed portions having diameters stepwisely smaller from the expanding flange portion, the one or more step-like formed portions continuing to the sleeve portion, and
the plunger member is configured by cold press molding the blank material according to deep-drawing molding, and closed forging, compression molding or a combined molding thereof, wherein during the cold press molding, a thickness of a bent corner portion, which at least makes the sleeve portion and the step-like formed portions continuous to each other, is configured to be increased by 30% or more relative to a thickness of the blank material, and then a hardened surface layer is formed on both of entire front and back sides of the plunger member by performing a soft nitriding treatment.

2. The plunger member used for the belt type continuously variable transmission according to claim 1, wherein
the hardened surface layer has a thickness of 4 μm or more relative to both of outermost and backmost surfaces of the plunger member.

3. The plunger member used for the belt type continuously variable transmission according to claim 1, wherein
the hardened surface layer has Vickers hardness of 400 Hv or more by the soft nitriding treatment.

4. The plunger member used for the belt type continuously variable transmission according to claim 1, wherein
the entire plunger member is formed with an equivalent plastic strain amount of 0.4 or more.

5. The plunger member used for the belt type continuously variable transmission according to claim 1, wherein
the bent corner portion, which at least makes the sleeve portion and the step-like formed portion continuous to each other in the plunger member, is configured to be provided with an equivalent plastic strain amount of 1.0 or more.

6. The plunger member used for the belt type continuously variable transmission according to claim 1, wherein
a hardened inner layer, which exists in an inner layer portion than the hardened surface layer in the plunger member, is formed having Vickers hardness of 18 Hv or more.

7. A manufacturing method of a plunger member used for a belt type continuously variable transmission, wherein
the plunger member is fixed to a shaft so as to face a movable-side pulley half body configuring a pulley together with a fixed-side pulley half body in the belt type continuously variable transmission to define an oil chamber formed by a cylinder member into a pulley oil chamber and a canceller oil chamber,
the plunger member comprising:
an expanding flange portion having a large diameter, the expanding flange portion formed on one end side by press molding a blank material, the expanding flange portion slidably abutting on the cylinder member;
a sleeve portion having a small diameter, the sleeve portion formed on the other end side, the sleeve portion fit and fixed to the shaft; and
one or more step-like formed portions having diameters stepwisely smaller from the expanding flange portion, the one or more step-like formed portions continuing to the sleeve portion, and
the plunger member is configured by cold press molding the blank material according to deep-drawing molding, and closed forging, compression molding or a combined molding thereof, wherein during the cold press molding, a thickness of a bent corner portion, which at least makes the sleeve portion and the step-like formed portions continuous to each other, is configured to be increased by 30% or more relative to a thickness of the blank material, and then a hardened surface layer is formed on both of entire front and back sides of the plunger member by performing a soft nitriding treatment.
